(19) United States
(12) Patent Application Publication
(10) Pub. No.: US 2026/0131898 A1
(43) Pub. Date: May 14, 2026

(54) HIGH VISIBILITY HOOK LATCH

(71) Applicant: Andres Hernandez, Yorba Linda, CA (US)

(72) Inventor: Andres Hernandez, Yorba Linda, CA (US)

(21) Appl. No.: 19/442,924

(22) Filed: Jan. 7, 2026

Related U.S. Application Data
(63) Continuation-in-part of application No. 19/391,930, filed on Nov. 17, 2025.
Application No. 19/391,930 is a continuation of application No. 17/180,729, filed on Feb. 20, 2021, now Pat. No. 12,473,095.

(51) Int. Cl. B64D 29/06; B64D 29/08; E05B 41/00; E05B 63/00; E05C 19/12; E05C 19/14

(52) U.S. Cl. CPC B64D 29/06; B64D 29/08; B66C 1/36; E05B 41/00; E05B 63/06; E05C 19/145; E05B 63/0056; E05C 19/12; E05Y 2900/502; Y10T 292/0949

(57) ABSTRACT

A hook latch may include a hook arm, a first elongate member, a second elongate member, a link, and four pivot points. The hook arm and the first elongate member may be connected at a first pivot point. The first elongate member and the second elongate member may be connected at a second pivot point. The hook arm and the link may be connected at a third pivot point. The second elongate member and the link may be connected at a fourth pivot point.

### INCORPORATION BY REFERENCE TO ANY PRIORITY APPLICATIONS

Any and all priority claims identified in the Application Data Sheet, or any correction thereto, are hereby incorporated by reference under 37 CFR 1.57. This application is a continuation-in-part of U.S. application Ser. No. 19/391930, filed Nov. 17, 2025, which is a continuation of U.S. application Ser. No. 17/180729, filed Feb. 20, 2021. Each of the aforementioned applications is incorporated by reference herein in its entirety, and each is hereby expressly made a part of this specification.

### BACKGROUND

### Field

This disclosure relates to latches; and more particularly, to aircraft latches.

### Related Art

Latches are used on the exterior surfaces of aircraft. The triggers of such latches are normally exposed and unprotected. These triggers can be hit accidentally during maintenance or the like. Unlocking of the latch at these times are undesirable. Unless some provision is made to positively lock the latch, the aircraft cowl may come down and close in a situation where the latch has not been completely locked. An operator should not be able to close the aircraft cowl with which the latch is associated, unless the latch is fully latched. It is also difficult to visually observe many of these latches to ensure that they are shut. If an aircraft is dispatched with disengaged latches, there is a potential for inflight-accidents. A latch that can present a flush surface with the aircraft body and indicate when the latch is in a locked or unlocked position is accordingly desired. There is a need for a latches that cannot be opened accidentally during service or the like and are visually easy to determine if they are shut. Many attempts to solve these issues have been attempted, resulting in heavy and/or complex devices. Therefore, what is needed is an aircraft nacelle latch that has increased visibility while simultaneously being lighter and more cost-efficient than conventional devices.

### SUMMARY

In some aspects, the techniques described herein relate to a high visibility hook latch including: a hook arm including: an arm having a distal end and a proximal end; a hook positioned at the distal end of the arm, the hook having a distal end; wherein the hook arm is configured to transition from a first configuration to a second configuration, wherein a distance between the proximal end of the arm and the distal end of the hook includes a first length when the hook arm is in the first configuration and the distance includes a second length when the hook arm is in the second configuration, the second length different from the first length; a handle pivotably attached to the distal end of the arm; a connector having a proximal end and a distal end, the distal end of the connector pivotably attached to the handle; a link, wherein the proximal end of the arm is pivotably attached to the link and the proximal end of the connector is pivotably attached to the link.

In some aspects, the techniques described herein relate to a high visibility hook latch, wherein the arm includes a female portion.

In some aspects, the techniques described herein relate to a high visibility hook latch, wherein the hook includes a male portion configured to be inserted into the female portion of the arm.

In some aspects, the techniques described herein relate to a high visibility hook latch, wherein the hook arm further includes a biasing member between the hook and the arm.

In some aspects, the techniques described herein relate to a high visibility hook latch, wherein the biasing member is a spring.

In some aspects, the techniques described herein relate to a high visibility hook latch, wherein the spring surrounds a portion of the male portion of the hook.

In some aspects, the techniques described herein relate to a high visibility hook latch, wherein the spring is configured to exert a force on the hook longitudinally away from the arm.

In some aspects, the techniques described herein relate to a high visibility hook latch, wherein at least a portion of the male portion of the hook includes threads.

In some aspects, the techniques described herein relate to a high visibility hook latch, wherein the arm further includes an adjustable nut configured to threadingly engage the threads of the male portion.

In some aspects, the techniques described herein relate to a high visibility hook latch, wherein the adjustable nut is further configured to rotate in a first direction.

In some aspects, the techniques described herein relate to a high visibility hook latch, wherein the hook arm is configured to transition from the first configuration to the second configuration when the adjustable nut is rotated in the first direction.

In some aspects, the techniques described herein relate to a high visibility hook latch, wherein the adjustable nut is further configured to rotate in a second direction, opposite the first direction.

In some aspects, the techniques described herein relate to a high visibility hook latch, wherein the hook arm is configured to transition from the second configuration to the first configuration when the adjustable nut is rotated in the second direction.

In some aspects, the techniques described herein relate to a high visibility hook latch, wherein the arm includes one or more openings.

In some aspects, the techniques described herein relate to a high visibility hook latch, wherein the adjustable nut includes one or more notches configured to receive a pin.

In some aspects, the techniques described herein relate to a high visibility hook latch, wherein the adjustable nut is configured to rotate after the pin is inserted into the one or more notches.

In some aspects, the techniques described herein relate to a high visibility hook latch, wherein the adjustable nut is configured to rotate when after the pin is inserted into the one or more notches and a user exerts a levering force on the pin.

In some aspects, the techniques described herein relate to a high visibility hook latch, wherein the one or more notches includes a plurality of notches circumferentially disposed around the adjustable nut.

In some aspects, the techniques described herein relate to a high visibility hook latch, wherein the one or more openings and the female portion define a cavity, wherein the adjustable nut is disposed within the cavity.

In some aspects, the techniques described herein relate to a high visibility hook latch, wherein the adjustable nut surrounds at least a portion of the male portion.

In some aspects, the techniques described herein relate to a high visibility hook latch, wherein the adjustable nut surrounds at least a portion of the threads of the male portion.

In some aspects, the techniques described herein relate to a high visibility hook latch, further including a hook stabilizer configured to inhibit the hook from rotating when the adjustable nut is rotated.

In some aspects, the techniques described herein relate to a high visibility hook latch, wherein the hook stabilizer includes a plate having an aperture and a projection extending generally towards a center of the aperture.

In some aspects, the techniques described herein relate to a high visibility hook latch, wherein the projection includes a generally quadrilateral shape.

In some aspects, the techniques described herein relate to a high visibility hook latch, wherein the aperture is configured to receive the male portion of the hook.

In some aspects, the techniques described herein relate to a high visibility hook latch, wherein the aperture includes a generally circular shape.

In some aspects, the techniques described herein relate to a high visibility hook latch, wherein the plate further includes a first end, a second end opposite the first end, and a flange extending from the first end.

In some aspects, the techniques described herein relate to a high visibility hook latch, wherein the flange is configured to engage the arm.

In some aspects, the techniques described herein relate to a high visibility hook latch, wherein the flange is configured to inhibit the movement of the hook stabilizer in the proximal end to the distal end direction.

In some aspects, the techniques described herein relate to a high visibility hook latch, wherein the adjustable nut includes at least one of a distal side, a proximal side, and a cylindrical surface.

In some aspects, the techniques described herein relate to a high visibility hook latch, wherein the hook stabilizer includes at least one of a proximal side and a distal side.

In some aspects, the techniques described herein relate to a high visibility hook latch, wherein the proximal side of the hook stabilizer includes one or more projections.

In some aspects, the techniques described herein relate to a high visibility hook latch, wherein the distal side of the adjustable nut includes one or more grooves configured receive the one or more projections of the hook stabilizer.

In some aspects, the techniques described herein relate to a high visibility hook latch, wherein the one or more projections of the hook stabilizer are configured to engage the one or more grooves of the adjustable nut, and wherein the engagement of the one or more projections and the one or more grooves inhibit the hook from rotating relative to the hook stabilizer.

In some aspects, the techniques described herein relate to a high visibility hook latch, further configured to transition from a folded configuration to a deployed configuration.

In some aspects, the techniques described herein relate to a high visibility hook latch, further including a locking assembly configured to inhibit the high visibility hook latch from transitioning from the folded configuration to the deployed configuration.

In some aspects, the techniques described herein relate to a high visibility hook latch, wherein the locking assembly includes one or more protrusions extending from the arm and one or more locking arms configured to engage the one or more protrusions.

In some aspects, the techniques described herein relate to a high visibility hook latch, wherein the engagement of the one or more protrusions and the one or more locking arms inhibit the high visibility hook latch from transitioning from the folded configuration to the deployed configuration.

In some aspects, the techniques described herein relate to a high visibility hook latch, wherein the one or more locking arms includes one or more projections configured to engage the one or more protrusions.

In some aspects, the techniques described herein relate to a high visibility hook latch, wherein the one or more locking arms includes one or more apertures configured to receive the one or more protrusions.

In some aspects, the techniques described herein relate to a high visibility hook latch, wherein the one or more locking arms have a generally triangular shape.

In some aspects, the techniques described herein relate to a high visibility hook latch, wherein the one or more locking arms are configured to transition from a locked position to an unlocked position.

In some aspects, the techniques described herein relate to a high visibility hook latch, wherein the high visibility hook latch is configured to be inhibited from transitioning from the folded configuration to the deployed configuration when the one or more locking arms are in the locked position.

In some aspects, the techniques described herein relate to a high visibility hook latch, wherein the high visibility hook latch is configured permit to transition from the folded configuration to the deployed configuration when the one or more locking arms are in the unlocked position.

In some aspects, the techniques described herein relate to a high visibility hook latch, wherein the locking assembly further includes a button configured to transition the locking assembly from the locked position to the unlocked position.

In some aspects, the techniques described herein relate to a high visibility hook latch, wherein the button is configured to transition the locking assembly from the locked position to the unlocked position when a user presses the button.

In some aspects, the techniques described herein relate to a high visibility hook latch, wherein the button is coupled to the one or more locking arms.

In some aspects, the techniques described herein relate to a high visibility hook latch, wherein the button is pivotably coupled to the handle.

In some aspects, the techniques described herein relate to a high visibility hook latch, wherein the handle includes an aperture and the button is positioned within the aperture.

In some aspects, the techniques described herein relate to a high visibility hook latch, wherein the locking assembly further includes a biasing member configured to bias the locking assembly towards the locked position.

In some aspects, the techniques described herein relate to a high visibility hook latch, wherein the biasing member is a spring.

In some aspects, the techniques described herein relate to a high visibility hook latch, wherein the spring includes a double torsion spring.

In some aspects, the techniques described herein relate to a high visibility hook latch, wherein the spring includes a torsion spring.

In some aspects, the techniques described herein relate to a high visibility hook latch, wherein the torsion spring includes a first arm configured to engage the button, a second arm configured to engage the arm, and a third arm configured to engage the handle.

In some aspects, the techniques described herein relate to a high visibility hook latch, wherein the handle and one or more locking arms include one or more corresponding eyelets configured to receive a strut.

In some aspects, the techniques described herein relate to a high visibility hook latch, wherein the strut is positioned within a cavity of the spring.

In some aspects, the techniques described herein relate to a high visibility hook latch, wherein the strut defines a pivot point, wherein the one or more locking arms are configured to pivot around.

In some aspects, the techniques described herein relate to a high visibility hook latch, wherein the connector includes a recess configured to receive the strut.

In some aspects, the techniques described herein relate to a high visibility hook latch, wherein the connector does not engage the strut when the high visibility hook latch is in the folded configuration.

In some aspects, the techniques described herein relate to a high visibility hook latch, wherein the button includes a flange configured to inhibit the button from passing through the aperture of the handle.

In some aspects, the techniques described herein relate to a high visibility hook latch, wherein the one or more locking arms are configured to pivot when the button is pressed.

In some aspects, the techniques described herein relate to a high visibility hook latch, wherein the one or more locking arms are configured to disengage from the one or more protrusions when the button is pressed.

In some aspects, the techniques described herein relate to a high visibility hook latch, wherein the high visibility hook latch is configured to transition from the folded configuration to the deployed configuration after the one or more locking arms disengage.

In some aspects, the techniques described herein relate to a high visibility hook latch, wherein the high visibility hook latch is configured to transition from the folded configuration to the deployed configuration after the locking assembly transitions to the unlocked position.

In some aspects, the techniques described herein relate to a high visibility hook latch, wherein the high visibility hook latch is configured to transition from the folded configuration to the deployed configuration after the button is pressed.

In some aspects, the techniques described herein relate to a high visibility hook latch, wherein the arm includes a first bend and a second bend, wherein the first bend and the second bend define a nook configured to receive a hollow strut of the link.

In some aspects, the techniques described herein relate to a high visibility hook latch, wherein the arm includes a first portion extending along a longitudinal axis, a second portion extending away from the longitudinal axis, and a third portion extending towards the longitudinal axis.

In some aspects, the techniques described herein relate to a high visibility hook latch, wherein the second portion and the third portion define a recess configured to receive a hollow strut of the link.

In some aspects, the techniques described herein relate to a high visibility hook latch, wherein the second portion and the third portion of define a generally L-shape.

In some aspects, the techniques described herein relate to a high visibility hook latch, wherein the third portion includes an enlarged end having a cavity configured to receive the hollow strut.

In some aspects, the techniques described herein relate to a high visibility hook latch, wherein the hollow strut defines a pivot point where the link pivots about relative to the hook arm.

In some aspects, the techniques described herein relate to a high visibility hook latch, wherein the second portion and the third portion are connected at a joint.

In some aspects, the techniques described herein relate to a high visibility hook latch, wherein the joint includes a protrusion and the handle includes a window configured to receive the protrusion.

In some aspects, the techniques described herein relate to a high visibility hook latch, wherein the protrusion is generally flat.

In some aspects, the techniques described herein relate to a high visibility hook latch, wherein the protrusion does not extend beyond the handle.

In some aspects, the techniques described herein relate to a high visibility hook latch, wherein an exterior surface of the protrusion is substantially, planarly aligned with an exterior surface of the handle.

In some aspects, the techniques described herein relate to a high visibility hook latch, wherein the hook arm further includes a platform connected to the distal end of the arm.

In some aspects, the techniques described herein relate to a high visibility hook latch, wherein the platform is connected to the distal end of the arm by one or more struts.

In some aspects, the techniques described herein relate to a high visibility hook latch, wherein the one or more struts includes one or more apertures configured to receive a strut.

In some aspects, the techniques described herein relate to a high visibility hook latch, further including the strut, wherein the strut defines a pivot point.

In some aspects, the techniques described herein relate to a high visibility hook latch, wherein the handle is configured pivot about the pivot point relative to the hook arm.

In some aspects, the techniques described herein relate to a high visibility hook latch, wherein the pivot point is positioned longitudinally between a distal end of the hook and a distal end of a female portion of the arm.

In some aspects, the techniques described herein relate to a high visibility hook latch, wherein an exterior surface of the platform is substantially, planarly aligned with an exterior surface of the handle.

In some aspects, the techniques described herein relate to a high visibility hook latch, wherein the hook further includes a platform positioned at a base of the hook.

In some aspects, the techniques described herein relate to a high visibility hook latch, wherein an exterior surface of the platform is substantially, planarly aligned with an exterior surface of the handle.

In some aspects, the techniques described herein relate to a high visibility hook latch, wherein the high visibility hook latch is configured to couple to an anchor of a mating sheet.

In some aspects, the techniques described herein relate to a high visibility hook latch, wherein the hook is configured to reduce a gap between the hook and the mating sheet.

In some aspects, the techniques described herein relate to a high visibility hook latch, wherein the handle and the connector include one or more corresponding eyelets configured to receive a strut.

In some aspects, the techniques described herein relate to a high visibility hook latch, wherein the strut defines a pivot point, wherein the handle is configured to pivot about the pivot point relative to the connector.

In some aspects, the techniques described herein relate to a high visibility hook latch, wherein the connector includes a first platform and a second platform.

In some aspects, the techniques described herein relate to a high visibility hook latch, wherein the second platform extends at an angle from the first platform.

In some aspects, the techniques described herein relate to a high visibility hook latch, wherein the second platform extends in a direction non-parallel to a longitudinal axis.

In some aspects, the techniques described herein relate to a high visibility hook latch, wherein the first platform extends in a direction parallel to the longitudinal axis.

In some aspects, the techniques described herein relate to a high visibility hook latch, further including a biasing member between the connector and the handle.

In some aspects, the techniques described herein relate to a high visibility hook latch, further including a spring having a first arm configured to engage the connector and a second arm configured to engage the handle.

In some aspects, the techniques described herein relate to a high visibility hook latch, wherein the spring includes a cavity, wherein the strut extends through the cavity.

In some aspects, the techniques described herein relate to a high visibility hook latch, wherein the spring is configured to facilitate the pivoting of the handle about the pivot point.

In some aspects, the techniques described herein relate to a high visibility hook latch, further configured to transition from a collapsed configuration to an expanded configuration.

In some aspects, the techniques described herein relate to a high visibility hook latch, wherein the spring is configured to facilitate the transition from the collapsed configuration to the expanded configuration.

In some aspects, the techniques described herein relate to a high visibility hook latch, wherein the one or more eyelets of the handle are oblong.

In some aspects, the techniques described herein relate to a high visibility hook latch, wherein the one or more eyelets of the handle are configured to allow the handle to move in a degree of freedom.

In some aspects, the techniques described herein relate to a high visibility hook latch, wherein the proximal end of the arm is pivotably attached to the link and the proximal end of the connector is pivotably attached to the link, the link having a first end attachment point, a mid-point pivot axis point, and a second end attachment point, wherein the hook arm is pivotably attached to the link at the mid-point pivot axis point, and wherein the connector is pivotably attached to the link at the second end attachment point

In some aspects, the techniques described herein relate to a high visibility hook latch, wherein the link is configured to provide a maximum reach of the high visibility hook latch.

In some aspects, the techniques described herein relate to a high visibility hook latch, wherein the link is substantially L-shaped.

In some aspects, the techniques described herein relate to a high visibility hook latch, wherein the hook is configured to engage a mating clevis.

In some aspects, the techniques described herein relate to a hook latch configured to be retrofitted in a cowling system, the hook latch including: a hook arm; a handle pivotably attached to a distal end of the arm; a connector having a proximal end and a distal end, the distal end of the connector pivotably attached to the handle; a link, wherein the proximal end of the arm is pivotably attached to the link and the proximal end of the connector is pivotably attached to the link, the link having a first end attachment point, a mid-point pivot axis point, and a second end attachment point, wherein the hook arm is pivotably attached to the link at the mid-point pivot axis point, and wherein the connector is pivotably attached to the link at the second end attachment point.

In some aspects, the techniques described herein relate to a hook latch, wherein the hook arm including: an arm having a distal end and a proximal end; and a hook positioned at the distal end of the arm, the hook having a distal end.

In some aspects, the techniques described herein relate to a hook latch, wherein the hook arm is configured to transition from a first configuration to a second configuration, wherein a distance between the proximal end of the arm and the distal end of the hook includes a first length when the hook arm is in the first configuration and the distance includes a second length when the hook arm is in the second configuration, the second length different from the first length.

In some aspects, the techniques described herein relate to a hook latch, wherein the arm includes a female portion.

In some aspects, the techniques described herein relate to a hook latch, wherein the hook includes a male portion configured to be inserted into the female portion of the arm.

In some aspects, the techniques described herein relate to a hook latch, wherein the hook arm further includes a biasing member between the hook and the arm.

In some aspects, the techniques described herein relate to a hook latch, wherein the biasing member is a spring.

In some aspects, the techniques described herein relate to a hook latch, wherein the spring surrounds a portion of the male portion of the hook.

In some aspects, the techniques described herein relate to a hook latch, wherein the spring is configured to exert a force on the hook longitudinally away from the arm.

In some aspects, the techniques described herein relate to a hook latch, wherein at least a portion of the male portion of the hook includes threads.

In some aspects, the techniques described herein relate to a hook latch, wherein the arm further includes an adjustable nut configured to threadingly engage the threads of the male portion.

In some aspects, the techniques described herein relate to a hook latch, wherein the adjustable nut is further configured to rotate in a first direction.

In some aspects, the techniques described herein relate to a hook latch, wherein the hook arm is configured to transition from the first configuration to the second configuration when the adjustable nut is rotated in the first direction.

In some aspects, the techniques described herein relate to a hook latch, wherein the adjustable nut is further configured to rotate in a second direction, opposite the first direction.

In some aspects, the techniques described herein relate to a hook latch, wherein the hook arm is configured to transition from the second configuration to the first configuration when the adjustable nut is rotated in the second direction.

In some aspects, the techniques described herein relate to a hook latch, wherein the arm includes one or more openings.

In some aspects, the techniques described herein relate to a hook latch, wherein the adjustable nut includes one or more notches configured to receive a pin.

In some aspects, the techniques described herein relate to a hook latch, wherein the adjustable nut is configured to rotate after the pin is inserted into the one or more notches.

In some aspects, the techniques described herein relate to a hook latch, wherein the adjustable nut is configured to rotate when after the pin is inserted into the one or more notches and a user exerts a levering force on the pin.

In some aspects, the techniques described herein relate to a hook latch, wherein the one or more notches includes a plurality of notches circumferentially disposed around the adjustable nut.

In some aspects, the techniques described herein relate to a hook latch, wherein the one or more openings and the female portion define a cavity, wherein the adjustable nut is disposed within the cavity.

In some aspects, the techniques described herein relate to a hook latch, wherein the adjustable nut surrounds at least a portion of the male portion.

In some aspects, the techniques described herein relate to a hook latch, wherein the adjustable nut surrounds at least a portion of the threads of the male portion.

In some aspects, the techniques described herein relate to a hook latch, further including a hook stabilizer configured to inhibit the hook from rotating when the adjustable nut is rotated.

In some aspects, the techniques described herein relate to a hook latch, wherein the hook stabilizer includes a plate having an aperture and a projection extending generally towards a center of the aperture.

In some aspects, the techniques described herein relate to a hook latch, wherein the projection includes a generally quadrilateral shape.

In some aspects, the techniques described herein relate to a hook latch, wherein the aperture is configured to receive the male portion of the hook.

In some aspects, the techniques described herein relate to a hook latch, wherein the aperture includes a generally circular shape.

In some aspects, the techniques described herein relate to a hook latch, wherein the plate further includes a first end, a second end opposite the first end, and a flange extending from the first end.

In some aspects, the techniques described herein relate to a hook latch, wherein the flange is configured to engage the arm.

In some aspects, the techniques described herein relate to a hook latch, wherein the flange is configured to inhibit the movement of the hook stabilizer in the proximal end to the distal end direction.

In some aspects, the techniques described herein relate to a hook latch, wherein the adjustable nut includes at least one of a distal side, a proximal side, and a cylindrical surface.

In some aspects, the techniques described herein relate to a hook latch, wherein the hook stabilizer includes at least one of a proximal side and a distal side.

In some aspects, the techniques described herein relate to a hook latch, wherein the proximal side of the hook stabilizer includes one or more projections.

In some aspects, the techniques described herein relate to a hook latch, wherein the distal side of the adjustable nut includes one or more grooves configured receive the one or more projections of the hook stabilizer.

In some aspects, the techniques described herein relate to a hook latch, wherein the one or more projections of the hook stabilizer are configured to engage the one or more grooves of the adjustable nut, and wherein the engagement of the one or more projections and the one or more grooves inhibit the hook from rotating relative to the hook stabilizer.

In some aspects, the techniques described herein relate to a hook latch, further configured to transition from a folded configuration to a deployed configuration.

In some aspects, the techniques described herein relate to a hook latch, further including a locking assembly configured to inhibit the hook latch from transitioning from the folded configuration to the deployed configuration.

In some aspects, the techniques described herein relate to a hook latch, wherein the locking assembly includes one or more protrusions extending from the arm and one or more locking arms configured to engage the one or more protrusions.

In some aspects, the techniques described herein relate to a hook latch, wherein the engagement of the one or more protrusions and the one or more locking arms inhibit the hook latch from transitioning from the folded configuration to the deployed configuration.

In some aspects, the techniques described herein relate to a hook latch, wherein the one or more locking arms includes one or more projections configured to engage the one or more protrusions.

In some aspects, the techniques described herein relate to a hook latch, wherein the one or more locking arms includes one or more apertures configured to receive the one or more protrusions.

In some aspects, the techniques described herein relate to a hook latch, wherein the one or more locking arms have a generally triangular shape.

In some aspects, the techniques described herein relate to a hook latch, wherein the one or more locking arms are configured to transition from a locked position to an unlocked position.

In some aspects, the techniques described herein relate to a hook latch, wherein the hook latch is configured to be inhibited from transitioning from the folded configuration to the deployed configuration when the one or more locking arms are in the locked position.

In some aspects, the techniques described herein relate to a hook latch, wherein the hook latch is configured permit to transition from the folded configuration to the deployed configuration when the one or more locking arms are in the unlocked position.

In some aspects, the techniques described herein relate to a hook latch, wherein the locking assembly further includes a button configured to transition the locking assembly from the locked position to the unlocked position.

In some aspects, the techniques described herein relate to a hook latch, wherein the button is configured to transition the locking assembly from the locked position to the unlocked position when a user presses the button.

In some aspects, the techniques described herein relate to a hook latch, wherein the button is coupled to the one or more locking arms.

In some aspects, the techniques described herein relate to a hook latch, wherein the button is pivotably coupled to the handle.

In some aspects, the techniques described herein relate to a hook latch, wherein the handle includes an aperture and the button is positioned within the aperture.

In some aspects, the techniques described herein relate to a hook latch, wherein the locking assembly further includes a biasing member configured to bias the locking assembly towards the locked position.

In some aspects, the techniques described herein relate to a hook latch, wherein the biasing member is a spring.

In some aspects, the techniques described herein relate to a hook latch, wherein the spring includes a double torsion spring.

In some aspects, the techniques described herein relate to a hook latch, wherein the spring includes a torsion spring.

In some aspects, the techniques described herein relate to a hook latch, wherein the torsion spring includes a first arm configured to engage the button, a second arm configured to engage the arm, and a third arm configured to engage the handle.

In some aspects, the techniques described herein relate to a hook latch, wherein the handle and one or more locking arms include one or more corresponding eyelets configured to receive a strut.

In some aspects, the techniques described herein relate to a hook latch, wherein the strut is positioned within a cavity of the spring.

In some aspects, the techniques described herein relate to a hook latch, wherein the strut defines a pivot point, wherein the one or more locking arms are configured to pivot around.

In some aspects, the techniques described herein relate to a hook latch, wherein the connector includes a recess configured to receive the strut.

In some aspects, the techniques described herein relate to a hook latch, wherein the connector does not engage the strut when the hook latch is in the folded configuration.

In some aspects, the techniques described herein relate to a hook latch, wherein the button includes a flange configured to inhibit the button from passing through the aperture of the handle.

In some aspects, the techniques described herein relate to a hook latch, wherein the one or more locking arms are configured to pivot when the button is pressed.

In some aspects, the techniques described herein relate to a hook latch, wherein the one or more locking arms are configured to disengage from the one or more protrusions when the button is pressed.

In some aspects, the techniques described herein relate to a hook latch, wherein the hook latch is configured to transition from the folded configuration to the deployed configuration after the one or more locking arms disengage.

In some aspects, the techniques described herein relate to a hook latch, wherein the hook latch is configured to transition from the folded configuration to the deployed configuration after the locking assembly transitions to the unlocked position.

In some aspects, the techniques described herein relate to a hook latch, wherein the hook latch is configured to transition from the folded configuration to the deployed configuration after the button is pressed.

In some aspects, the techniques described herein relate to a hook latch, wherein the arm includes a first bend and a second bend, wherein the first bend and the second bend define a nook configured to receive a hollow strut of the link.

In some aspects, the techniques described herein relate to a hook latch, wherein the arm includes a first portion extending along a longitudinal axis, a second portion extending away from the longitudinal axis, and a third portion extending towards the longitudinal axis.

In some aspects, the techniques described herein relate to a hook latch, wherein the second portion and the third portion define a recess configured to receive a hollow strut of the link.

In some aspects, the techniques described herein relate to a hook latch, wherein the second portion and the third portion of define a generally L-shape.

In some aspects, the techniques described herein relate to a hook latch, wherein the third portion includes an enlarged end having a cavity configured to receive the hollow strut.

In some aspects, the techniques described herein relate to a hook latch, wherein the hollow strut defines a pivot point where the link pivots about relative to the hook arm.

In some aspects, the techniques described herein relate to a hook latch, wherein the second portion and the third portion are connected at a joint.

In some aspects, the techniques described herein relate to a hook latch, wherein the joint includes a protrusion and the handle includes a window configured to receive the protrusion.

In some aspects, the techniques described herein relate to a hook latch, wherein the protrusion is generally flat.

In some aspects, the techniques described herein relate to a hook latch, wherein the protrusion does not extend beyond the handle.

In some aspects, the techniques described herein relate to a hook latch, wherein an exterior surface of the protrusion is substantially, planarly aligned with an exterior surface of the handle.

In some aspects, the techniques described herein relate to a hook latch, wherein the hook arm further includes a platform connected to the distal end of the arm.

In some aspects, the techniques described herein relate to a hook latch, wherein the platform is connected to the distal end of the arm by one or more struts.

In some aspects, the techniques described herein relate to a hook latch, wherein the one or more struts includes one or more apertures configured to receive a strut.

In some aspects, the techniques described herein relate to a hook latch, further including the strut, wherein the strut defines a pivot point.

In some aspects, the techniques described herein relate to a hook latch, wherein the handle is configured pivot about the pivot point relative to the hook arm.

In some aspects, the techniques described herein relate to a hook latch, wherein the pivot point is positioned longitudinally between a distal end of the hook and a distal end of a female portion of the hook arm.

In some aspects, the techniques described herein relate to a hook latch, wherein an exterior surface of the platform is substantially, planarly aligned with an exterior surface of the handle.

In some aspects, the techniques described herein relate to a hook latch, wherein the hook further includes a platform positioned at a base of the hook.

In some aspects, the techniques described herein relate to a hook latch, wherein an exterior surface of the platform is substantially, planarly aligned with an exterior surface of the handle.

In some aspects, the techniques described herein relate to a hook latch, wherein the hook latch is configured to couple to an anchor of a mating sheet.

In some aspects, the techniques described herein relate to a hook latch, wherein the hook is configured to reduce a gap between the hook and the mating sheet.

In some aspects, the techniques described herein relate to a hook latch, wherein the handle and the connector include one or more corresponding eyelets configured to receive a strut.

In some aspects, the techniques described herein relate to a hook latch, wherein the strut defines a pivot point, wherein the handle is configured to pivot about the pivot point relative to the connector.

In some aspects, the techniques described herein relate to a hook latch, wherein the connector includes a first platform and a second platform.

In some aspects, the techniques described herein relate to a hook latch, wherein the second platform extends at an angle from the first platform.

In some aspects, the techniques described herein relate to a hook latch, wherein the second platform extends in a direction non-parallel to a longitudinal axis.

In some aspects, the techniques described herein relate to a hook latch, wherein the first platform extends in a direction parallel to the longitudinal axis.

In some aspects, the techniques described herein relate to a hook latch, further including a biasing member between the connector and the handle.

In some aspects, the techniques described herein relate to a hook latch, further including a spring having a first arm configured to engage the connector and a second arm configured to engage the handle.

In some aspects, the techniques described herein relate to a hook latch, wherein the spring includes a cavity, wherein the strut extends through the cavity.

In some aspects, the techniques described herein relate to a hook latch, wherein the spring is configured to facilitate the pivoting of the handle about the pivot point.

In some aspects, the techniques described herein relate to a hook latch, further configured to transition from a collapsed configuration to an expanded configuration.

In some aspects, the techniques described herein relate to a hook latch, wherein the spring is configured to facilitate the transition from the collapsed configuration to the expanded configuration.

In some aspects, the techniques described herein relate to a hook latch, wherein the one or more eyelets of the handle are oblong.

In some aspects, the techniques described herein relate to a hook latch system configured to be used in a cowling system, the hook latch including: a mating clevis; and a hook latch including: a hook arm; a handle pivotably attached to a distal end of the arm; a connector having a proximal end and a distal end, the distal end of the connector pivotably attached to the handle; a link, wherein the proximal end of the arm is pivotably attached to the link and the proximal end of the connector is pivotably attached to the link.

In some aspects, the techniques described herein relate to a hook latch, wherein the hook arm including: an arm having a distal end and a proximal end; and a hook positioned at the distal end of the arm, the hook having a distal end.

In some aspects, the techniques described herein relate to a hook latch, wherein the hook arm is configured to transition from a first configuration to a second configuration, wherein a distance between the proximal end of the arm and the distal end of the hook includes a first length when the hook arm is in the first configuration and the distance includes a second length when the hook arm is in the second configuration, the second length different from the first length.

In some aspects, the techniques described herein relate to a hook latch system, wherein the arm includes a female portion.

In some aspects, the techniques described herein relate to a hook latch system, wherein the hook includes a male portion configured to be inserted into the female portion of the arm.

In some aspects, the techniques described herein relate to a hook latch system, wherein the hook arm further includes a biasing member between the hook and the arm.

In some aspects, the techniques described herein relate to a hook latch system, wherein the biasing member is a spring.

In some aspects, the techniques described herein relate to a hook latch system, wherein the spring surrounds a portion of the male portion of the hook.

In some aspects, the techniques described herein relate to a hook latch system, wherein the spring is configured to exert a force on the hook longitudinally away from the arm.

In some aspects, the techniques described herein relate to a hook latch system, wherein at least a portion of the male portion of the hook includes threads.

In some aspects, the techniques described herein relate to a hook latch system, wherein the arm further includes an adjustable nut configured to threadingly engage the threads of the male portion.

In some aspects, the techniques described herein relate to a hook latch system, wherein the adjustable nut is further configured to rotate in a first direction.

In some aspects, the techniques described herein relate to a hook latch system, wherein the hook arm is configured to transition from the first configuration to the second configuration when the adjustable nut is rotated in the first direction.

In some aspects, the techniques described herein relate to a hook latch system, wherein the adjustable nut is further configured to rotate in a second direction, opposite the first direction.

In some aspects, the techniques described herein relate to a hook latch system, wherein the hook arm is configured to transition from the second configuration to the first configuration when the adjustable nut is rotated in the second direction.

In some aspects, the techniques described herein relate to a hook latch system, wherein the arm includes one or more openings.

In some aspects, the techniques described herein relate to a hook latch system, wherein the adjustable nut includes one or more notches configured to receive a pin.

In some aspects, the techniques described herein relate to a hook latch system, wherein the adjustable nut is configured to rotate after the pin is inserted into the one or more notches.

In some aspects, the techniques described herein relate to a hook latch system, wherein the adjustable nut is configured to rotate when after the pin is inserted into the one or more notches and a user exerts a levering force on the pin.

In some aspects, the techniques described herein relate to a hook latch system, wherein the one or more notches includes a plurality of notches circumferentially disposed around the adjustable nut.

In some aspects, the techniques described herein relate to a hook latch system, wherein the one or more openings and the female portion define a cavity, wherein the adjustable nut is disposed within the cavity.

In some aspects, the techniques described herein relate to a hook latch system, wherein the adjustable nut surrounds at least a portion of the male portion.

In some aspects, the techniques described herein relate to a hook latch system, wherein the adjustable nut surrounds at least a portion of the threads of the male portion.

In some aspects, the techniques described herein relate to a hook latch system, further including a hook stabilizer configured to inhibit the hook from rotating when the adjustable nut is rotated.

In some aspects, the techniques described herein relate to a hook latch system, wherein the hook stabilizer includes a plate having an aperture and a projection extending generally towards a center of the aperture.

In some aspects, the techniques described herein relate to a hook latch system, wherein the projection includes a generally quadrilateral shape.

In some aspects, the techniques described herein relate to a hook latch system, wherein the aperture is configured to receive the male portion of the hook.

In some aspects, the techniques described herein relate to a hook latch system, wherein the aperture includes a generally circular shape.

In some aspects, the techniques described herein relate to a hook latch system, wherein the plate further includes a first end, a second end opposite the first end, and a flange extending from the first end.

In some aspects, the techniques described herein relate to a hook latch system, wherein the flange is configured to engage the arm.

In some aspects, the techniques described herein relate to a hook latch system, wherein the flange is configured to inhibit the movement of the hook stabilizer in the proximal end to the distal end direction.

In some aspects, the techniques described herein relate to a hook latch system, wherein the adjustable nut includes at least one of a distal side, a proximal side, and a cylindrical surface.

In some aspects, the techniques described herein relate to a hook latch system, wherein the hook stabilizer includes at least one of a proximal side and a distal side.

In some aspects, the techniques described herein relate to a hook latch system, wherein the proximal side of the hook stabilizer includes one or more projections.

In some aspects, the techniques described herein relate to a hook latch system, wherein the distal side of the adjustable nut includes one or more grooves configured receive the one or more projections of the hook stabilizer.

In some aspects, the techniques described herein relate to a hook latch system, wherein the one or more projections of the hook stabilizer are configured to engage the one or more grooves of the adjustable nut, and wherein the engagement of the one or more projections and the one or more grooves inhibit the hook from rotating relative to the hook stabilizer.

In some aspects, the techniques described herein relate to a hook latch system, further configured to transition from a folded configuration to a deployed configuration.

In some aspects, the techniques described herein relate to a hook latch system, further including a locking assembly configured to inhibit the hook latch system from transitioning from the folded configuration to the deployed configuration.

In some aspects, the techniques described herein relate to a hook latch system, wherein the locking assembly includes one or more protrusions extending from the arm and one or more locking arms configured to engage the one or more protrusions.

In some aspects, the techniques described herein relate to a hook latch system, wherein the engagement of the one or more protrusions and the one or more locking arms inhibit the hook latch from transitioning from the folded configuration to the deployed configuration.

In some aspects, the techniques described herein relate to a hook latch system, wherein the one or more locking arms includes one or more projections configured to engage the one or more protrusions.

In some aspects, the techniques described herein relate to a hook latch system, wherein the one or more locking arms includes one or more apertures configured to receive the one or more protrusions.

In some aspects, the techniques described herein relate to a hook latch system, wherein the one or more locking arms have a generally triangular shape.

In some aspects, the techniques described herein relate to a hook latch system, wherein the one or more locking arms are configured to transition from a locked position to an unlocked position.

In some aspects, the techniques described herein relate to a hook latch system, wherein the hook latch is configured to be inhibited from transitioning from the folded configuration to the deployed configuration when the one or more locking arms are in the locked position.

In some aspects, the techniques described herein relate to a hook latch system, wherein the hook latch is configured permit to transition from the folded configuration to the deployed configuration when the one or more locking arms are in the unlocked position.

In some aspects, the techniques described herein relate to a hook latch system, wherein the locking assembly further includes a button configured to transition the locking assembly from the locked position to the unlocked position.

In some aspects, the techniques described herein relate to a hook latch system, wherein the button is configured to transition the locking assembly from the locked position to the unlocked position when a user presses the button.

In some aspects, the techniques described herein relate to a hook latch system, wherein the button is coupled to the one or more locking arms.

In some aspects, the techniques described herein relate to a hook latch system, wherein the button is pivotably coupled to the handle.

In some aspects, the techniques described herein relate to a hook latch system, wherein the handle includes an aperture and the button is positioned within the aperture.

In some aspects, the techniques described herein relate to a hook latch system, wherein the locking assembly further includes a biasing member configured to bias the locking assembly towards the locked position.

In some aspects, the techniques described herein relate to a hook latch system, wherein the biasing member is a spring.

In some aspects, the techniques described herein relate to a hook latch system, wherein the spring includes a double torsion spring.

In some aspects, the techniques described herein relate to a hook latch system, wherein the spring includes a torsion spring.

In some aspects, the techniques described herein relate to a hook latch system, wherein the torsion spring includes a first arm configured to engage the button, a second arm configured to engage the arm, and a third arm configured to engage the handle.

In some aspects, the techniques described herein relate to a hook latch system, wherein the handle and one or more locking arms include one or more corresponding eyelets configured to receive a strut.

In some aspects, the techniques described herein relate to a hook latch system, wherein the strut is positioned within a cavity of the spring.

In some aspects, the techniques described herein relate to a hook latch system, wherein the strut defines a pivot point, wherein the one or more locking arms are configured to pivot around.

In some aspects, the techniques described herein relate to a hook latch system, wherein the connector includes a recess configured to receive the strut.

In some aspects, the techniques described herein relate to a hook latch system, wherein the connector does not engage the strut when the hook latch system is in the folded configuration.

In some aspects, the techniques described herein relate to a hook latch system, wherein the button includes a flange configured to inhibit the button from passing through the aperture of the handle.

In some aspects, the techniques described herein relate to a hook latch system, wherein the one or more locking arms are configured to pivot when the button is pressed.

In some aspects, the techniques described herein relate to a hook latch system, wherein the one or more locking arms are configured to disengage from the one or more protrusions when the button is pressed.

In some aspects, the techniques described herein relate to a hook latch system, wherein the hook latch is configured to transition from the folded configuration to the deployed configuration after the one or more locking arms disengage.

In some aspects, the techniques described herein relate to a hook latch system, wherein the hook latch is configured to transition from the folded configuration to the deployed configuration after the locking assembly transitions to the unlocked position.

In some aspects, the techniques described herein relate to a hook latch system, wherein the hook latch is configured to transition from the folded configuration to the deployed configuration after the button is pressed.

In some aspects, the techniques described herein relate to a hook latch system, wherein the arm includes a first bend and a second bend, wherein the first bend and the second bend define a nook configured to receive a hollow strut of the link.

In some aspects, the techniques described herein relate to a hook latch system, wherein the arm includes a first portion extending along a longitudinal axis, a second portion extending away from the longitudinal axis, and a third portion extending towards the longitudinal axis.

In some aspects, the techniques described herein relate to a hook latch system, wherein the second portion and the third portion define a recess configured to receive a hollow strut of the link.

In some aspects, the techniques described herein relate to a hook latch system, wherein the second portion and the third portion of define a generally L-shape.

In some aspects, the techniques described herein relate to a hook latch system, wherein the third portion includes an enlarged end having a cavity configured to receive the hollow strut.

In some aspects, the techniques described herein relate to a hook latch system, wherein the hollow strut defines a pivot point where the link pivots about relative to the hook arm.

In some aspects, the techniques described herein relate to a hook latch system, wherein the second portion and the third portion are connected at a joint.

In some aspects, the techniques described herein relate to a hook latch system, wherein the joint includes a protrusion and the handle includes a window configured to receive the protrusion.

In some aspects, the techniques described herein relate to a hook latch system, wherein the protrusion is generally flat.

In some aspects, the techniques described herein relate to a hook latch system, wherein the protrusion does not extend beyond the handle.

In some aspects, the techniques described herein relate to a hook latch system, wherein an exterior surface of the protrusion is substantially, planarly aligned with an exterior surface of the handle.

In some aspects, the techniques described herein relate to a hook latch system, wherein the hook arm further includes a platform connected to the distal end of the arm.

In some aspects, the techniques described herein relate to a hook latch system, wherein the platform is connected to the distal end of the arm by one or more struts.

In some aspects, the techniques described herein relate to a hook latch system, wherein the one or more struts includes one or more apertures configured to receive a strut.

In some aspects, the techniques described herein relate to a hook latch system, further including the strut, wherein the strut defines a pivot point.

In some aspects, the techniques described herein relate to a hook latch system, wherein the handle is configured pivot about the pivot point relative to the hook arm.

In some aspects, the techniques described herein relate to a hook latch system, wherein the pivot point is positioned longitudinally between a distal end of the hook and a distal end of a female portion of the arm.

In some aspects, the techniques described herein relate to a hook latch system, wherein an exterior surface of the platform is substantially, planarly aligned with an exterior surface of the handle.

In some aspects, the techniques described herein relate to a hook latch system, wherein the hook further includes a platform positioned at a base of the hook.

In some aspects, the techniques described herein relate to a hook latch system, wherein an exterior surface of the platform is substantially, planarly aligned with an exterior surface of the handle.

In some aspects, the techniques described herein relate to a hook latch system, wherein the hook latch is configured to couple to an anchor of a mating sheet.

In some aspects, the techniques described herein relate to a hook latch system, wherein the hook is configured to reduce a gap between the hook and the mating sheet.

In some aspects, the techniques described herein relate to a hook latch system, wherein the handle and the connector include one or more corresponding eyelets configured to receive a strut.

In some aspects, the techniques described herein relate to a hook latch system, wherein the strut defines a pivot point, wherein the handle is configured to pivot about the pivot point relative to the connector.

In some aspects, the techniques described herein relate to a hook latch system, wherein the connector includes a first platform and a second platform.

In some aspects, the techniques described herein relate to a hook latch system, wherein the second platform extends at an angle from the first platform.

In some aspects, the techniques described herein relate to a hook latch system, wherein the second platform extends in a direction non-parallel to a longitudinal axis.

In some aspects, the techniques described herein relate to a hook latch system, wherein the first platform extends in a direction parallel to the longitudinal axis.

In some aspects, the techniques described herein relate to a hook latch system, further including a biasing member between the connector and the handle.

In some aspects, the techniques described herein relate to a hook latch system, further including a spring having a first arm configured to engage the connector and a second arm configured to engage the handle.

In some aspects, the techniques described herein relate to a hook latch system, wherein the spring includes a cavity, wherein the strut extends through the cavity.

In some aspects, the techniques described herein relate to a hook latch system, wherein the spring is configured to facilitate the pivoting of the handle about the pivot point.

In some aspects, the techniques described herein relate to a hook latch system, further configured to transition from a collapsed configuration to an expanded configuration.

In some aspects, the techniques described herein relate to a hook latch system, wherein the spring is configured to facilitate the transition from the collapsed configuration to the expanded configuration.

In some aspects, the techniques described herein relate to a hook latch system, wherein the one or more eyelets of the handle are oblong.

In some aspects, the techniques described herein relate to a hook latch system, wherein the one or more eyelets of the handle are configured to allow the handle to move in a degree of freedom.

In some aspects, the techniques described herein relate to a hook latch system, wherein the proximal end of the arm is pivotably attached to the link and the proximal end of the connector is pivotably attached to the link, the link having a first end attachment point, a mid-point pivot axis point, and a second end attachment point, wherein the hook arm is pivotably attached to the link at the mid-point pivot axis point, and wherein the connector is pivotably attached to the link at the second end attachment point

In some aspects, the techniques described herein relate to a hook latch system, wherein the link is configured to provide a maximum reach of the hook latch system.

In some aspects, the techniques described herein relate to a hook latch system, wherein the link is substantially L-shaped.

In some aspects, the techniques described herein relate to a hook latch system, wherein the hook is configured to engage a mating clevis.

In some aspects, the techniques described herein relate to a hook latch assembly including a base; a door; and a high visibility hook latch configured to be retrofitted on aircraft for holding the door in a closed position relative to the base, the latch including: a hook arm; a handle pivotably attached to a distal end of the arm; a connector having a proximal end and a distal end, the distal end of the connector pivotably attached to the handle; a link, wherein the proximal end of the arm is pivotably attached to the link and the proximal end of the connector is pivotably attached to the link.

In some aspects, the techniques described herein relate to a hook latch assembly, wherein the hook arm including: an arm having a distal end and a proximal end; and a hook positioned at the distal end of the arm, the hook having a distal end.

In some aspects, the techniques described herein relate to a hook latch assembly, wherein the hook arm is configured to transition from a first configuration to a second configuration, wherein a distance between the proximal end of the arm and the distal end of the hook includes a first length when the hook arm is in the first configuration and the distance includes a second length when the hook arm is in the second configuration, the second length different from the first length.

In some aspects, the techniques described herein relate to a hook latch assembly, wherein the arm includes a female portion.

In some aspects, the techniques described herein relate to a hook latch assembly, wherein the hook includes a male portion configured to be inserted into the female portion of the arm.

In some aspects, the techniques described herein relate to a hook latch assembly, wherein the hook arm further includes a biasing member between the hook and the arm.

In some aspects, the techniques described herein relate to a hook latch assembly, wherein the biasing member is a spring.

In some aspects, the techniques described herein relate to a hook latch assembly, wherein the spring surrounds a portion of the male portion of the hook.

In some aspects, the techniques described herein relate to a hook latch assembly, wherein the spring is configured to exert a force on the hook longitudinally away from the arm.

In some aspects, the techniques described herein relate to a hook latch assembly, wherein at least a portion of the male portion of the hook includes threads.

In some aspects, the techniques described herein relate to a hook latch assembly, wherein the arm further includes an adjustable nut configured to threadingly engage the threads of the male portion.

In some aspects, the techniques described herein relate to a hook latch assembly, wherein the adjustable nut is further configured to rotate in a first direction.

In some aspects, the techniques described herein relate to a hook latch assembly, wherein the hook arm is configured to transition from the first configuration to the second configuration when the adjustable nut is rotated in the first direction.

In some aspects, the techniques described herein relate to a hook latch assembly, wherein the adjustable nut is further configured to rotate in a second direction, opposite the first direction.

In some aspects, the techniques described herein relate to a hook latch assembly, wherein the hook arm is configured to transition from the second configuration to the first configuration when the adjustable nut is rotated in the second direction.

In some aspects, the techniques described herein relate to a hook latch assembly, wherein the arm includes one or more openings.

In some aspects, the techniques described herein relate to a hook latch assembly, wherein the adjustable nut includes one or more notches configured to receive a pin.

In some aspects, the techniques described herein relate to a hook latch assembly, wherein the adjustable nut is configured to rotate after the pin is inserted into the one or more notches.

In some aspects, the techniques described herein relate to a hook latch assembly, wherein the adjustable nut is configured to rotate when after the pin is inserted into the one or more notches and a user exerts a levering force on the pin.

In some aspects, the techniques described herein relate to a hook latch assembly, wherein the one or more notches includes a plurality of notches circumferentially disposed around the adjustable nut.

In some aspects, the techniques described herein relate to a hook latch assembly, wherein the one or more openings and the female portion define a cavity, wherein the adjustable nut is disposed within the cavity.

In some aspects, the techniques described herein relate to a hook latch assembly, wherein the adjustable nut surrounds at least a portion of the male portion.

In some aspects, the techniques described herein relate to a hook latch assembly, wherein the adjustable nut surrounds at least a portion of the threads of the male portion.

In some aspects, the techniques described herein relate to a hook latch assembly, further including a hook stabilizer configured to inhibit the hook from rotating when the adjustable nut is rotated.

In some aspects, the techniques described herein relate to a hook latch assembly, wherein the hook stabilizer includes a plate having an aperture and a projection extending generally towards a center of the aperture.

In some aspects, the techniques described herein relate to a hook latch assembly, wherein the projection includes a generally quadrilateral shape.

In some aspects, the techniques described herein relate to a hook latch assembly, wherein the aperture is configured to receive the male portion of the hook.

In some aspects, the techniques described herein relate to a hook latch assembly, wherein the aperture includes a generally circular shape.

In some aspects, the techniques described herein relate to a hook latch assembly, wherein the plate further includes a first end, a second end opposite the first end, and a flange extending from the first end.

In some aspects, the techniques described herein relate to a hook latch assembly, wherein the flange is configured to engage the arm.

In some aspects, the techniques described herein relate to a hook latch assembly, wherein the flange is configured to inhibit the movement of the hook stabilizer in the proximal end to the distal end direction.

In some aspects, the techniques described herein relate to a hook latch assembly, wherein the adjustable nut includes at least one of a distal side, a proximal side, and a cylindrical surface.

In some aspects, the techniques described herein relate to a hook latch assembly, wherein the hook stabilizer includes at least one of a proximal side and a distal side.

In some aspects, the techniques described herein relate to a hook latch assembly, wherein the proximal side of the hook stabilizer includes one or more projections.

In some aspects, the techniques described herein relate to a hook latch assembly, wherein the distal side of the adjustable nut includes one or more grooves configured receive the one or more projections of the hook stabilizer.

In some aspects, the techniques described herein relate to a hook latch assembly, wherein the one or more projections of the hook stabilizer are configured to engage the one or more grooves of the adjustable nut, and wherein the engagement of the one or more projections and the one or more grooves inhibit the hook from rotating relative to the hook stabilizer.

In some aspects, the techniques described herein relate to a hook latch assembly, further configured to transition from a folded configuration to a deployed configuration.

In some aspects, the techniques described herein relate to a hook latch assembly, further including a locking assembly configured to inhibit the high visibility hook latch from transitioning from the folded configuration to the deployed configuration.

In some aspects, the techniques described herein relate to a hook latch assembly, wherein the locking assembly includes one or more protrusions extending from the arm and one or more locking arms configured to engage the one or more protrusions.

In some aspects, the techniques described herein relate to a hook latch assembly, wherein the engagement of the one or more protrusions and the one or more locking arms inhibit the high visibility hook latch from transitioning from the folded configuration to the deployed configuration.

In some aspects, the techniques described herein relate to a hook latch assembly, wherein the one or more locking arms includes one or more projections configured to engage the one or more protrusions.

In some aspects, the techniques described herein relate to a hook latch assembly, wherein the one or more locking arms includes one or more apertures configured to receive the one or more protrusions.

In some aspects, the techniques described herein relate to a hook latch assembly, wherein the one or more locking arms have a generally triangular shape.

In some aspects, the techniques described herein relate to a hook latch assembly, wherein the one or more locking arms are configured to transition from a locked position to an unlocked position.

In some aspects, the techniques described herein relate to a hook latch assembly, wherein the high visibility hook latch is configured to be inhibited from transitioning from the folded configuration to the deployed configuration when the one or more locking arms are in the locked position.

In some aspects, the techniques described herein relate to a hook latch assembly, wherein the high visibility hook latch is configured permit to transition from the folded configuration to the deployed configuration when the one or more locking arms are in the unlocked position.

In some aspects, the techniques described herein relate to a hook latch assembly, wherein the locking assembly further includes a button configured to transition the locking assembly from the locked position to the unlocked position.

In some aspects, the techniques described herein relate to a hook latch assembly, wherein the button is configured to transition the locking assembly from the locked position to the unlocked position when a user presses the button.

In some aspects, the techniques described herein relate to a hook latch assembly, wherein the button is coupled to the one or more locking arms.

In some aspects, the techniques described herein relate to a hook latch assembly, wherein the button is pivotably coupled to the handle.

In some aspects, the techniques described herein relate to a hook latch assembly, wherein the handle includes an aperture and the button is positioned within the aperture.

In some aspects, the techniques described herein relate to a hook latch assembly, wherein the locking assembly further includes a biasing member configured to bias the locking assembly towards the locked position.

In some aspects, the techniques described herein relate to a hook latch assembly, wherein the biasing member is a spring.

In some aspects, the techniques described herein relate to a hook latch assembly, wherein the spring includes a double torsion spring.

In some aspects, the techniques described herein relate to a hook latch assembly, wherein the spring includes a torsion spring.

In some aspects, the techniques described herein relate to a hook latch assembly, wherein the torsion spring includes a first arm configured to engage the button, a second arm configured to engage the arm, and a third arm configured to engage the handle.

In some aspects, the techniques described herein relate to a hook latch assembly, wherein the handle and one or more locking arms include one or more corresponding eyelets configured to receive a strut.

In some aspects, the techniques described herein relate to a hook latch assembly, wherein the strut is positioned within a cavity of the spring.

In some aspects, the techniques described herein relate to a hook latch assembly, wherein the strut defines a pivot point, wherein the one or more locking arms are configured to pivot around.

In some aspects, the techniques described herein relate to a hook latch assembly, wherein the connector includes a recess configured to receive the strut.

In some aspects, the techniques described herein relate to a hook latch assembly, wherein the connector does not engage the strut when the high visibility hook latch is in the folded configuration.

In some aspects, the techniques described herein relate to a hook latch assembly, wherein the button includes a flange configured to inhibit the button from passing through the aperture of the handle.

In some aspects, the techniques described herein relate to a hook latch assembly, wherein the one or more locking arms are configured to pivot when the button is pressed.

In some aspects, the techniques described herein relate to a hook latch assembly, wherein the one or more locking arms are configured to disengage from the one or more protrusions when the button is pressed.

In some aspects, the techniques described herein relate to a hook latch assembly, wherein the high visibility hook latch is configured to transition from the folded configuration to the deployed configuration after the one or more locking arms disengage.

In some aspects, the techniques described herein relate to a hook latch assembly, wherein the high visibility hook latch is configured to transition from the folded configuration to the deployed configuration after the locking assembly transitions to the unlocked position.

In some aspects, the techniques described herein relate to a hook latch assembly, wherein the high visibility hook latch is configured to transition from the folded configuration to the deployed configuration after the button is pressed.

In some aspects, the techniques described herein relate to a hook latch assembly, wherein the arm includes a first bend and a second bend, wherein the first bend and the second bend define a nook configured to receive a hollow strut of the link.

In some aspects, the techniques described herein relate to a hook latch assembly, wherein the arm includes a first portion extending along a longitudinal axis, a second portion extending away from the longitudinal axis, and a third portion extending towards the longitudinal axis.

In some aspects, the techniques described herein relate to a hook latch assembly, wherein the second portion and the third portion define a recess configured to receive a hollow strut of the link.

In some aspects, the techniques described herein relate to a hook latch assembly, wherein the second portion and the third portion of define a generally L-shape.

In some aspects, the techniques described herein relate to a hook latch assembly, wherein the third portion includes an enlarged end having a cavity configured to receive the hollow strut.

In some aspects, the techniques described herein relate to a hook latch assembly, wherein the hollow strut defines a pivot point where the link pivots about relative to the hook arm.

In some aspects, the techniques described herein relate to a hook latch assembly, wherein the second portion and the third portion are connected at a joint.

In some aspects, the techniques described herein relate to a hook latch assembly, wherein the joint includes a protrusion and the handle includes a window configured to receive the protrusion.

In some aspects, the techniques described herein relate to a hook latch assembly, wherein the protrusion is generally flat.

In some aspects, the techniques described herein relate to a hook latch assembly, wherein the protrusion does not extend beyond the handle.

In some aspects, the techniques described herein relate to a hook latch assembly, wherein an exterior surface of the protrusion is substantially, planarly aligned with an exterior surface of the handle.

In some aspects, the techniques described herein relate to a hook latch assembly, wherein the hook arm further includes a platform connected to the distal end of the arm.

In some aspects, the techniques described herein relate to a hook latch assembly, wherein the platform is connected to the distal end of the arm by one or more struts.

In some aspects, the techniques described herein relate to a hook latch assembly, wherein the one or more struts includes one or more apertures configured to receive a strut.

In some aspects, the techniques described herein relate to a hook latch assembly, further including the strut, wherein the strut defines a pivot point.

In some aspects, the techniques described herein relate to a hook latch assembly, wherein the handle is configured pivot about the pivot point relative to the hook arm.

In some aspects, the techniques described herein relate to a hook latch assembly, wherein the pivot point is positioned longitudinally between a distal end of the hook and a distal end of a female portion of the arm.

In some aspects, the techniques described herein relate to a hook latch assembly, wherein an exterior surface of the platform is substantially, planarly aligned with an exterior surface of the handle.

In some aspects, the techniques described herein relate to a hook latch assembly, wherein the hook further includes a platform positioned at a base of the hook.

In some aspects, the techniques described herein relate to a hook latch assembly, wherein an exterior surface of the platform is substantially, planarly aligned with an exterior surface of the handle.

In some aspects, the techniques described herein relate to a hook latch assembly, wherein the high visibility hook latch is configured to couple to an anchor of a mating sheet.

In some aspects, the techniques described herein relate to a hook latch assembly, wherein the hook is configured to reduce a gap between the hook and the mating sheet.

In some aspects, the techniques described herein relate to a hook latch assembly, wherein the handle and the connector include one or more corresponding eyelets configured to receive a strut.

In some aspects, the techniques described herein relate to a hook latch assembly, wherein the strut defines a pivot point, wherein the handle is configured to pivot about the pivot point relative to the connector.

In some aspects, the techniques described herein relate to a hook latch assembly, wherein the connector includes a first platform and a second platform.

In some aspects, the techniques described herein relate to a hook latch assembly, wherein the second platform extends at an angle from the first platform.

In some aspects, the techniques described herein relate to a hook latch assembly, wherein the second platform extends in a direction non-parallel to a longitudinal axis.

In some aspects, the techniques described herein relate to a hook latch assembly, wherein the first platform extends in a direction parallel to the longitudinal axis.

In some aspects, the techniques described herein relate to a hook latch assembly, further including a biasing member between the connector and the handle.

In some aspects, the techniques described herein relate to a hook latch assembly, further including a spring having a first arm configured to engage the connector and a second arm configured to engage the handle.

In some aspects, the techniques described herein relate to a hook latch assembly, wherein the spring includes a cavity, wherein the strut extends through the cavity.

In some aspects, the techniques described herein relate to a hook latch assembly, wherein the spring is configured to facilitate the pivoting of the handle about the pivot point.

In some aspects, the techniques described herein relate to a hook latch assembly, further configured to transition from a collapsed configuration to an expanded configuration.

In some aspects, the techniques described herein relate to a hook latch assembly, wherein the spring is configured to facilitate the transition from the collapsed configuration to the expanded configuration.

In some aspects, the techniques described herein relate to a hook latch assembly, wherein the one or more eyelets of the handle are oblong.

In some aspects, the techniques described herein relate to a hook latch assembly, wherein the one or more eyelets of the handle are configured to allow the handle to move in a degree of freedom.

In some aspects, the techniques described herein relate to a hook latch assembly, wherein the proximal end of the arm is pivotably attached to the link and the proximal end of the connector is pivotably attached to the link, the link having a first end attachment point, a mid-point pivot axis point, and a second end attachment point, wherein the hook arm is pivotably attached to the link at the mid-point pivot axis point, and wherein the connector is pivotably attached to the link at the second end attachment point

In some aspects, the techniques described herein relate to a hook latch assembly, wherein the link is configured to provide a maximum reach of the high visibility hook latch.

In some aspects, the techniques described herein relate to a hook latch assembly, wherein the link is substantially L-shaped.

In some aspects, the techniques described herein relate to a hook latch assembly, wherein the hook is configured to engage a mating clevis.

In some aspects, the techniques described herein relate to a hook latch configured to be retrofitted in a cowling system, the hook latch including: a hook arm; a handle pivotably attached to a distal portion of the hook arm; a connector having a proximal end and a distal end, the distal end of the connector pivotably attached to the handle; a link including a first pivot point, a second pivot point, and a third pivot point, a proximal end of the hook arm is pivotably attached to the link at the second pivot point, and the proximal end of the connector is pivotably attached to the link at the third pivot point; wherein the second pivot point configured to at least partially orbit around the first pivot point, the third pivot point configured to at least partially orbit around the first pivot point.

In some aspects, the techniques described herein relate to a hook latch, wherein the third pivot point is configured to additionally orbit around the second pivot point

In some aspects, the techniques described herein relate to a hook latch, wherein the first pivot point is configured to be stationary when the at least one of the first pivot point and the second pivot point at least partially orbit the first pivot point.

In some aspects, the techniques described herein relate to a hook latch, further configured to transition from a folded configuration to an unfolded configuration.

In some aspects, the techniques described herein relate to a hook latch, wherein the second pivot point is configured to at least partially orbit the first pivot point as the hook latch transitions from the folded configuration to the unfolded configuration.

In some aspects, the techniques described herein relate to a hook latch, wherein the third pivot point is configured to at least partially orbit the first pivot point as the hook latch transitions from the folded configuration to the unfolded configuration.

In some aspects, the techniques described herein relate to a hook latch, further including a first distance between a distal end of the hook arm and the first pivot point when the hook latch is in the folded configuration and a second distance between the distal end of the hook arm and the first pivot point when the hook latch is in the unfolded configuration, wherein the second distance greater than the first distance.

In some aspects, the techniques described herein relate to a hook latch configured to be retrofitted in a cowling system, the hook latch including: a hook arm; a first elongate member; a second elongate member; a link; a first pivot point, at least one of the first elongate member and the hook arm are configured to at least partially oscillate around the first pivot point; a second pivot point, at least one of the first elongate member and the second elongate member are configured to at least partially oscillate around the second pivot point; a third pivot point, at least one of the link and the hook arm are configured to at least partially oscillate around the third pivot point; and a fourth pivot point, at least one of the link and the second elongate member are configured to at least partially oscillate around the fourth pivot point.

In some aspects, the techniques described herein relate to a hook latch, wherein: the hook arm and the first elongate member are connected at the first pivot point; the first elongate member and the second elongate member are connected at the second pivot point; the hook arm and the link are connected at the third pivot point; and the second elongate member and the link are connected at the fourth pivot point.

In some aspects, the techniques described herein relate to a hook latch, further including a fifth pivot point, wherein the hook latch is configured to at least partially oscillate around the fifth pivot point.

In some aspects, the techniques described herein relate to a hook latch, wherein the fifth pivot point is stationary relative to at least one of the first pivot point, the second pivot point, the third pivot point, and the third pivot point.

In some aspects, the techniques described herein relate to a hook latch, wherein the hook arm is configured to couple with a clevis and the fifth pivot point is configured to be stationary relative to the clevis.

In some aspects, the techniques described herein relate to a hook latch configured to be retrofitted in a cowling system, the hook latch including: an elongate hook arm having a hook at a hook end; a handle pivotably attached to the hook arm at the other end, away from the hook end; an elongate connector having a link end and a handle end, the handle end of the connector pivotably attached to the handle; a link including a main connection point configured to connect to the exterior of an aircraft engine, a hook-arm pivot point, and a connector pivot point, the hook end of the hook arm is pivotably attached to the link at the hook-arm pivot point, and the link end of the connector is pivotably attached to the link at the connector pivot point; the hook-arm pivot point of the link and the connector pivot point of the link are configured to respond to a force on the handle in a direction away from the aircraft to begin a disconnection process by simultaneously pivoting around the main connection point away from the exterior of the aircraft engine, thereby lengthening the distance between the main connection point and the hook end of the elongate hook arm. Dep. Respond to a force rotating the free end of the handle toward the link by shortening the hook arm and securing **.

In some aspects, the techniques described herein relate to a hook latch, wherein the third pivot point is configured to additionally orbit around the second pivot point

In some aspects, the techniques described herein relate to a hook latch, wherein the first pivot point is configured to be stationary when the at least one of the first pivot point and the second pivot point at least partially orbit the first pivot point.

In some aspects, the techniques described herein relate to a hook latch, further configured to transition from a folded configuration to an unfolded configuration.

In some aspects, the techniques described herein relate to a hook latch, wherein the second pivot point is configured to at least partially orbit the first pivot point as the hook latch transitions from the folded configuration to the unfolded configuration.

In some aspects, the techniques described herein relate to a hook latch, wherein the third pivot point is configured to at least partially orbit the first pivot point as the hook latch transitions from the folded configuration to the unfolded configuration.

In some aspects, the techniques described herein relate to a hook latch, further including a first distance between a distal end of the hook arm and the first pivot point when the hook latch is in the folded configuration and a second distance between the distal end of the hook arm and the first pivot point when the hook latch is in the unfolded configuration, wherein the second distance greater than the first distance.

In some aspects, the techniques described herein relate to a hook latch configured to be retrofitted in a cowling system, the hook latch including: a hook arm; a first elongate member; a second elongate member; a link; a first pivot point, at least one of the first elongate member and the hook arm are configured to at least partially oscillate around the first pivot point; a second pivot point, at least one of the first elongate member and the second elongate member are configured to at least partially oscillate around the second pivot point; a third pivot point, at least one of the link and the hook arm are configured to at least partially oscillate around the third pivot point; and a fourth pivot point, at least one of the link and the second elongate member are configured to at least partially oscillate around the fourth pivot point.

In some aspects, the techniques described herein relate to a hook latch, wherein: the hook arm and the first elongate member are connected at the first pivot point; the first elongate member and the second elongate member are connected at the second pivot point; the hook arm and the link are connected at the third pivot point; and the second elongate member and the link are connected at the fourth pivot point.

In some aspects, the techniques described herein relate to a hook latch, further including a fifth pivot point, wherein the hook latch is configured to at least partially oscillate around the fifth pivot point.

### BRIEF DESCRIPTION OF THE DRAWINGS

Having thus described aspects of the disclosure in general terms, reference is now made to the accompanying figures, which show different views of different example embodiments.

FIG. 1 shows a perspective view of the device.

FIG. 2 shows a side view of the device.

FIG. 2B shows a side view of another embodiment the device including a faster means comprising a screw-and-nut connection.

FIG. 3 shows a side view of the device in the free travel position.

FIG. 4 shows side view of the device in the open position.

FIG. 5 shows a side view of the device disengaged from a mating clevis.

FIG. 6 a side view of an exemplary embodiment of an assembly including the device securing a base to a door.

FIG. 7A is a top left perspective view of an exemplary embodiment of a hook latch assembly.

FIG. 7B is a top down view of the hook latch assembly of FIG. 7A.

FIG. 7C is a cross-sectional view of the hook latch assembly of FIG. 7B along axis A.

FIG. 7D is bottom left perspective view of the hook latch assembly of FIG. 7A.

FIG. 8A is a side view of a hook portion of an embodiment of a hook latch.

FIG. 8B is a top left perspective view of the hook portion of FIG. 8A.

FIG. 9A is a top left perspective view of a connector of an embodiment of a hook latch.

FIG. 9B is side view of the connector of FIG. 9A.

FIG. 9C is a bottom-up view of the connector of FIG. 9A.

FIG. 10A is a side view of a button of an embodiment of a hook latch.

FIG. 10B is a bottom-up view of the button of FIG. 10A.

FIG. 10C is a top left perspective view of the button of FIG. 10A.

FIG. 11A is a side view of an elongate arm of an embodiment of a hook latch.

FIG. 11B is a top-down view of the elongate arm of FIG. 11A.

FIG. 11C is a top left perspective view of the elongate arm of FIG. 11A.

FIG. 12A is a bottom-up view of a handle of an embodiment of a hook latch.

FIG. 12B is top left perspective view of the handle of FIG. 12A.

FIG. 13A is side view of an adjustable nut and a hook stabilizer of an embodiment of a hook latch.

FIG. 13B is a top-down view of the adjustable nut and the hook stabilizer of FIG. 13A.

FIG. 13C is a top right perspective view of the adjustable nut of FIG. 13A.

FIG. 13D is a rear left perspective view of the adjustable nut of FIG. 13A.

FIG. 13E is a front view of the hook stabilizer of FIG. 13A.

FIG. 13F is a rear view of the hook stabilizer of FIG. 13A.

FIG. 13G is a rear left perspective view of the hook stabilizer of FIG. 13A.

FIG. 14A is a side view of a hook latch assembly connected to an aircraft clevis while the hook latch assembly is in a folded configuration.

FIG. 14B is a side view of a hook latch assembly connected to an aircraft clevis while the hook latch assembly is transitioning to an unfolded configuration.

FIG. 14C is a side view of a hook latch assembly disconnected to an aircraft clevis while the hook latch assembly is in a fully unfolded configuration.

FIG. 14D is a side view of a hook latch assembly disconnected to an aircraft clevis and hanging from the aircraft while the hook latch assembly is in a fully unfolded configuration.

FIG. 15 is a top perspective view of a hook latch.

FIG. 16 is a bottom perspective view of a hook latch.

FIG. 17 is a rear view of a hook latch.

FIG. 18 is a top left perspective view of an embodiment of a biasing member.

FIG. 19 is a top left perspective view of another embodiment of a biasing member.

FIG. 20 is an exploded view of a pin assembly.

FIG. 21 is a top left perspective view of various rods, pins, and struts.

FIG. 22A is a side view of a link.

FIG. 22B is a rear view of the link of FIG. 22A.

### DETAILED DESCRIPTION

In the following detailed description, numerous details, examples, and embodiments are described. However, it will be clear and apparent to one skilled in the art that the inventions are not limited to the embodiments set forth and that the inventions can be adapted for any of several applications. For example, the disclosure and utility is not limited by the type of environment or application in which the systems, methods, and processes are described herein, meaning that they may be successfully utilized in connection with industries other than the aircraft industry.

For purposes of the present description, certain aspects, advantages, and novel features are described herein. It is to be understood that not necessarily all such advantages may be achieved in accordance with any particular embodiment of the disclosure. Thus, for example, those skilled in the art will recognize that the inventions may be embodied or carried out in a manner that achieves one advantage or group of advantages as taught herein without necessarily achieving other advantages as may be taught or suggested herein.

The device of the present disclosure may be used as a high visibility hook latch for an aircraft nacelle and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

The various elements of the description may be related in the following example fashion. It is not intended to limit the scope or nature of the relationships between the various elements and the following examples are presented as illustrative examples only.

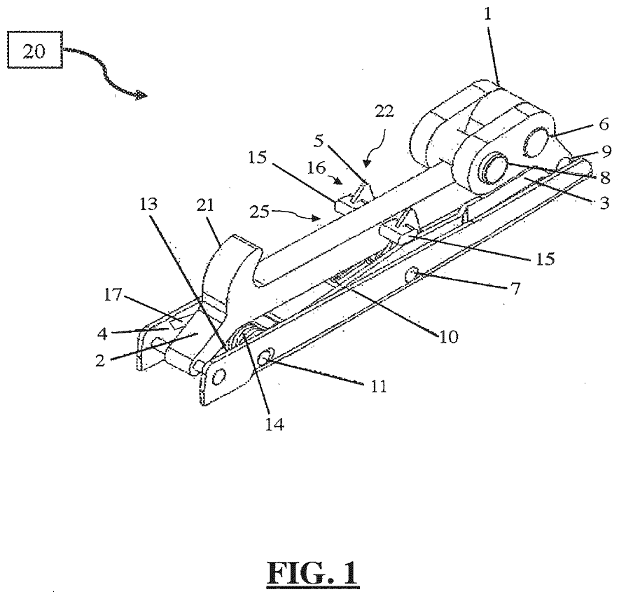

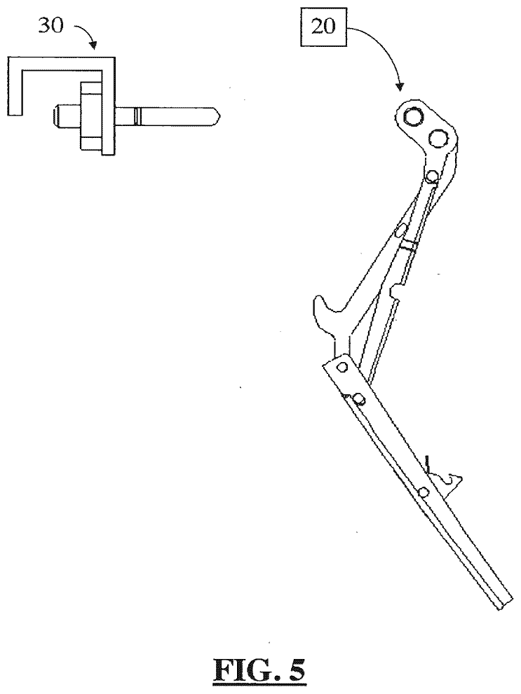

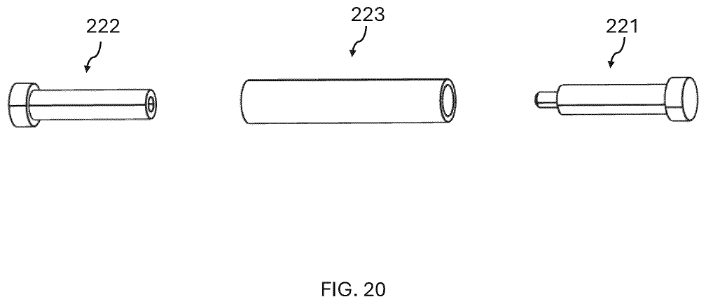

By way of example, and referring to the Figures, some embodiments include a high visibility hook latch for aircraft nacelles, the high visibility hook latch 20 comprising a hook arm 2 having a proximal end and a distal end, a handle 4 pivotably attached to the proximal end of the hook arm 2, and a connector 3 having a first connector end (e.g., a hook arm end) pivotably attached to the distal end of the hook arm 2 via a link 1 and a second connector end (e.g., a link end) pivotably attached to the handle 4 proximate to the hook arm 2 via a pin assembly 11. In some embodiments, the pin assembly 11 comprises a female press pin, male press pin, and/or a sleeve (see e.g., FIG. 20). As shown in FIGS. 1-6, the hook arm 2 may include a main hook 21 extending from the proximal end thereof, wherein the main hook 21 is sized and shaped to engage with the respective mating structure 30, such as a mating clevis on the aircraft nacelle.

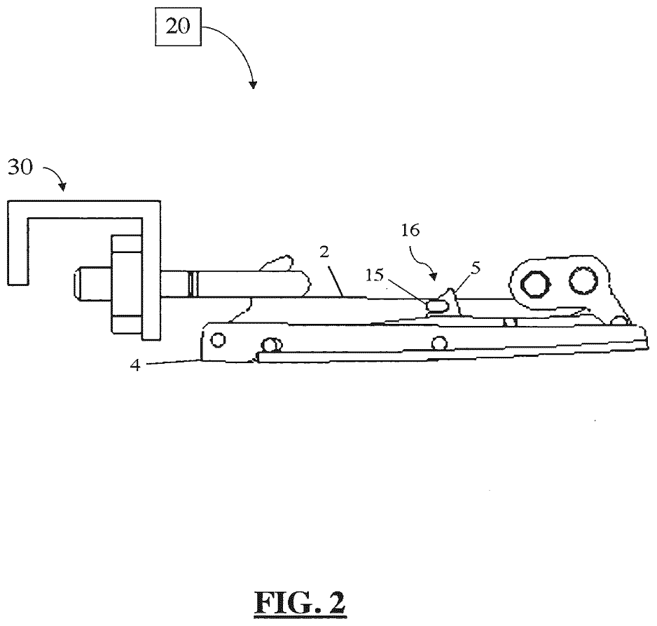

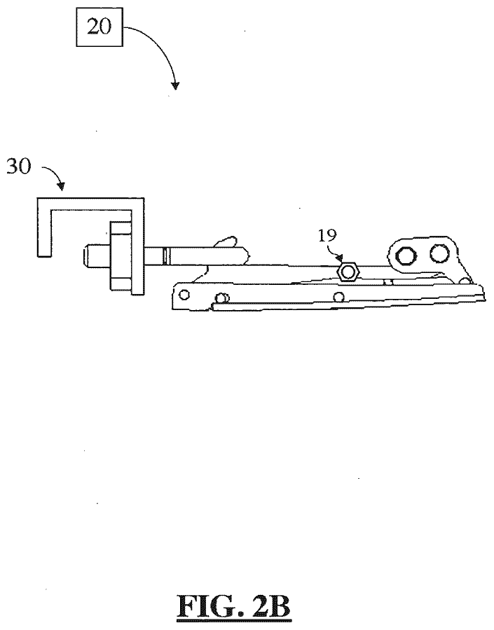

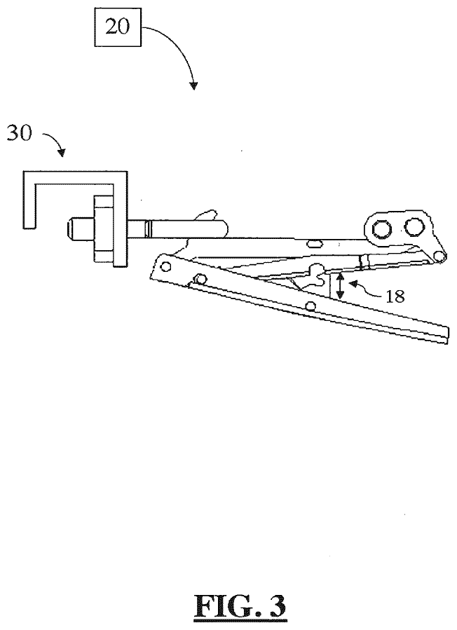

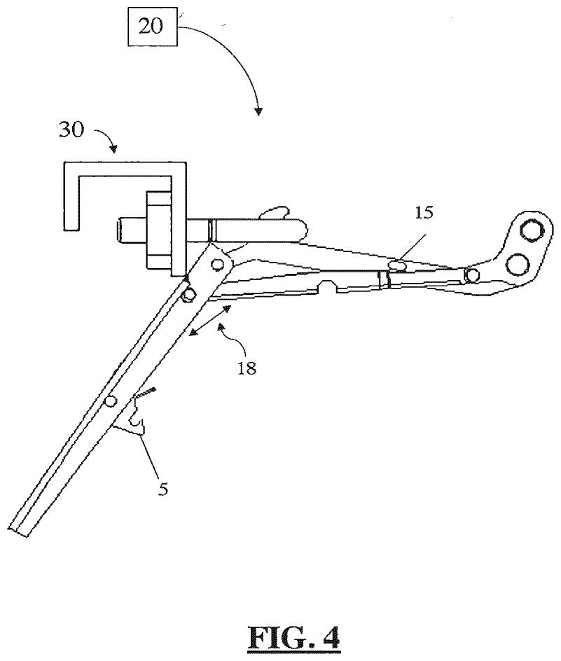

With continued reference to the Figures, the high visibility latch 20 may have at least three positioning configurations. FIG. 2 illustrates the latch 20 in a closed position configuration. FIG. 3 illustrates the latch 20 in a free travel position configuration. FIG. 4 illustrates the latch 20 in an open position configuration.

As also shown in the Figures, the link 1 may be a substantially, rounded L-shaped component, wherein a length of the link 1 provides the reach or take up that the latch 20 will be able to accommodate. For example, the length may comprise a distance between a first end pivot axis and a second point pivot axis. Additionally, or alternatively, the length may comprise a distance between the first end pivot axis and a midpoint-pivot axis. As will be discussed in more detail elsewhere, as the hook latch 20 transitions from the closed position to an open position, the effective length of hook arm 2 may increase according to the length, and this increase in effective length may allow the hook arm 2 to disengage the mating clevis. The link 1 may have three connections: a first end is connected to a mounting bushing 8, a mid-point pivot axis is connected to the hook arm 2, and a far axis is connected to the connector 3 via a second rivet 9, wherein the connector 3 is also connected via a sliding axis to the handle 4. The bushing 8 may connect and pivot around a structure mounting pin 6, wherein the link 1 is secured to the bushing 8 on one end and the other end may be connected to the hook 2 via a pin 6. The connector 3 may drive the rotational movement of the link 1. For example, the connector 3 may push the handle 4 such that the handle rotates about a pivot point defined by where the hook arm 2 and the handle 4 are connected. Additionally, or alternatively, the connector 3 may pull the connector 3 at the far axis. As seen in a comparison of FIGS. 2B and 4, the connector may pull the link such that the link transitions from a 9 O'clock direction to a 1 O'clock direction. The handle 4 is sized and shaped to pivot around the hook arm 2 via a first rivet 7.

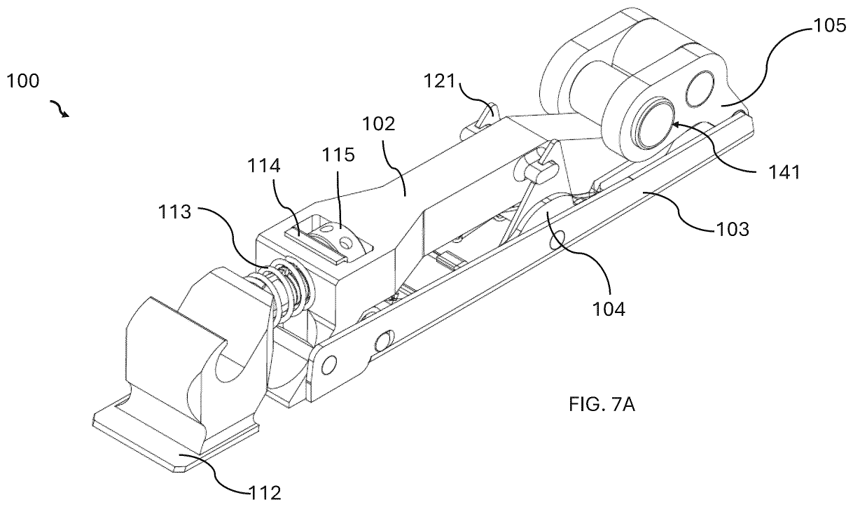

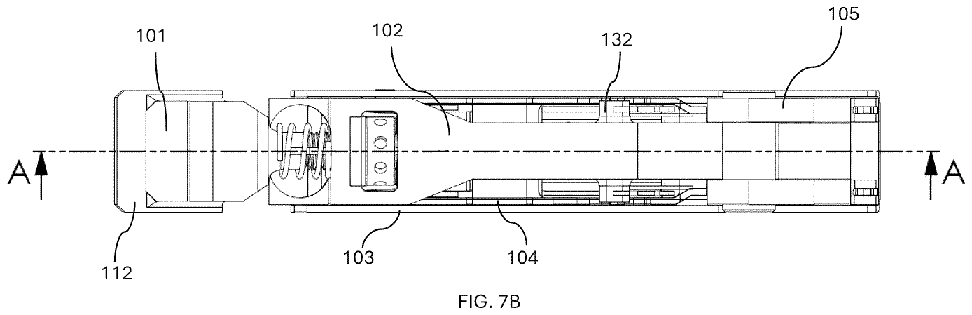

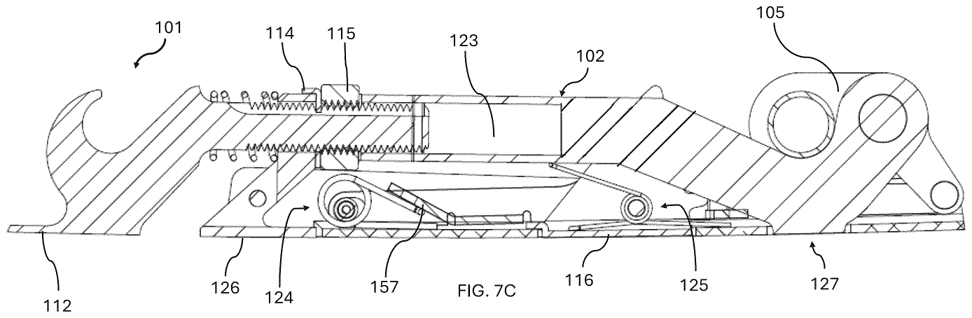

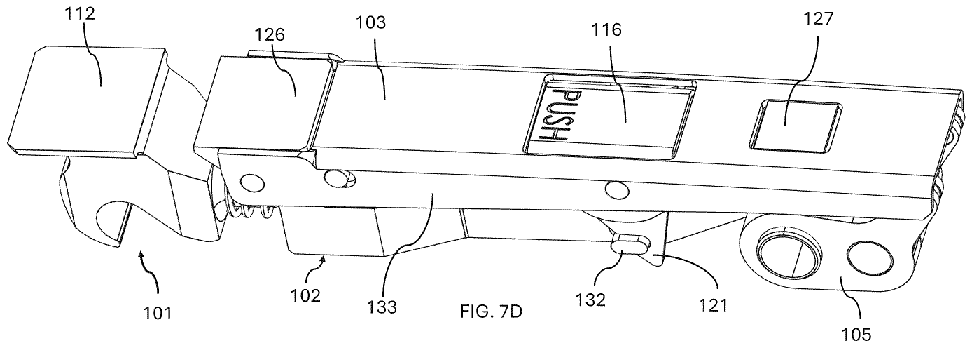

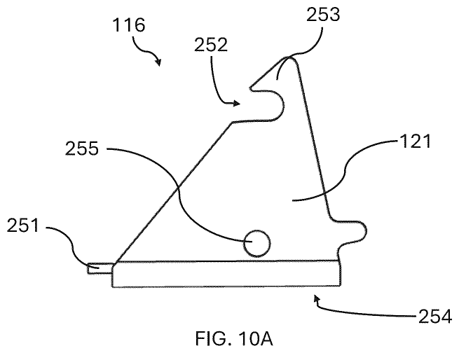

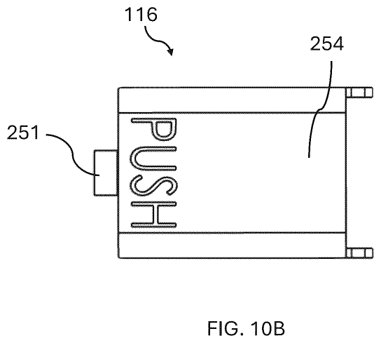

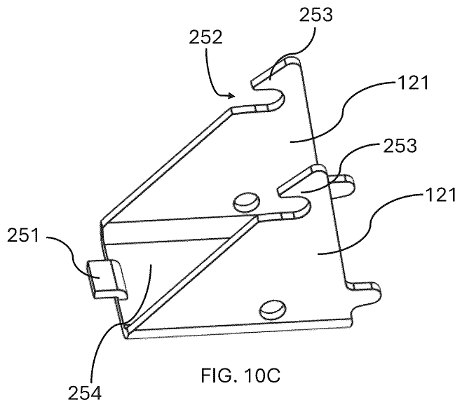

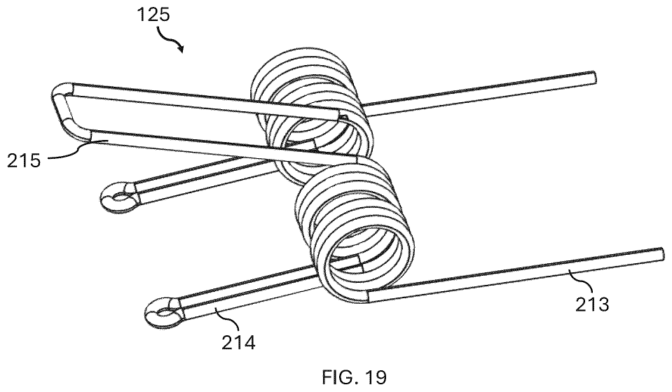

The hook latch 20 may also comprise a trigger 5 extending from the handle 4 (see e.g., FIGS. 10A-10C, 19, and corresponding disclosure below). The trigger 5 may be spring closed via a trigger spring 10 (see e.g., FIGS. 7C, 19, and its corresponding disclosure below) and may engage with the hook arm 2 with a securing feature built into the hook arm. As such, once the trigger 5 is pushed and disengaged, the hook arm 2 may spring open via the connector spring 14. Although some of the figures disclosed herein depict a hook arm 2 that has a fixed length, in some embodiments, the hook arm 2 may have an adjustable length to accommodate different device lengths, wherein the length of the hook arm may be adjusted via a hook arm adjustment means 22. For example, the hook arm may have the adjustment means shown and described in FIGS. 7A-7C and its corresponding disclosure.

The link may be sized and shaped to be locked in position against a mounting pin 6 via the bushing 8 when the latch 20 is in the closed configuration. For example, the hook arm 2 may include a canted portion having a corresponding groove. The bushing 8 may engage the groove of the canted portion when the latch 20 is in the closed configuration. Further, the trigger may engage protrusions extending from the hook arm 2, inhibiting the hook arm from transitions to the open configuration. While in the closed configuration, the hook arm 2 may be axially loaded from the proximal end via the hook that engages with the mating clevis. In this closed position, the hook latch 20 can be loaded to its mechanical properties level.

With the hook still axially loaded, the trigger 5 may be pushed open, allowing the handle 4 to rotate open a few degrees (such as about 10 degrees), which may be controlled by a slot 17 in the handle 4 that limits the sliding of the connector 3. This places the latch 20 into its free travel configuration, making it ready to be completely opened.

To place the latch 20 in its open configuration, the handle 4 may be grabbed and pulled. This grabbing and pulling may overcome an over-center lock that the latch was in and ultimately allowing the hook arm 2 to unravel around the bushing 8 via the link 1, which in turn is rotating open around the bushing 8. Once this movement is completed, the handle 4 is fully extending open and the latch 20 is disengaged. As discussed in more detail below, the link rotating around the bushing may increase the effective length of the hook arm 2, allowing the hook arm 2 to disengage clevis. This change in effective length of the hook arm 2 may be accomplished by the unique shape of the link. For example, the first end pivot point 8 and the mid-point pivot point 6 may a first axis. The mid-point pivot point 6 and the second end pivot point 9 may define a second axis. The first axis and the second axis are not parallel to each other. In some embodiments, the first axis and the second axis may be more perpendicular than parallel.

With continued reference to the Figures, a high visibility hook latch device is illustrated. The latch device 20 may comprise a hook arm 2 having a proximal end and a distal end, a handle 4 pivotably attached to the proximal end of the hook arm 2, and a connector 3 having a first connector end pivotably attached to the distal end of the hook arm via a link and a second connector end pivotably attached to the handle 4 proximate to the hook arm 2. As depicted in FIG. 1, the position of where the handle 4 and the hook of the hook arm 2 are rotatable connect may be beyond the hook (e.g., longitudinally beyond). For example, the hook arm 2 may have a projection extending from a bend or shank of the hook. This projection may extend longitudinally beyond a tip of the hook. The projection may include an aperture, eyelet, or the like to receive a pin, rod, or strut connecting the handle 4 to the hook arm 2. Additionally, or alternatively, the projection may extend into a slot 17 defined at least partially by over hanged portions of the handle 4.

Further, in some embodiments, the latch 20 may comprise a handle 4, adjustment means for adjusting an angle of inclination 18 of the handle 4 in a closed position of the latch 20, wherein said means may be controllable on the handle 4. Further, the latch 20 may comprise a safety device 16 suitable for preventing the latch 20 being operated by means of the handle 4 and presenting a dimension 18 that is adjustable. Further, in some embodiments, the means for adjusting the angle of inclination 18 comprises the safety device 16. Further, the adjustment means 16 are operable when the latch 20 is in the closed position. Further, the latch 20 may comprise a main hook 21 configurable to attach to a mating clevis 30. Further, the safety device 16 may comprise a safety hook 5 extending from the handle 4, the safety hook 5 configured to engage a rod 15 extending from the hook arm 2 when the latch 20 is in a closed position, and enable the position of the of the safety hook 5 relative to the rod 15 to be adjusted.

In one embodiment, the high visibility hook latch 20 may comprise a hook arm 2 having a proximal end and a distal end, a handle 4 pivotably attached to the proximal end of the hook arm 2 and a connector 3 having a first connector end pivotably attached to the distal end of the hook arm 2 via a link 1 and a second connector end pivotably attached to the handle 4 proximate to where the hook arm 2 is attached to the handle 4. For example, the hook arm 2 may be connected to the handle 4 by a pin, rod, strut, or the link at a first position. The connector 3 may be connected to the handle 4 by a pin, rod, strut or the like at a second position. The first position may be adjacent to the second position. For example, the first position may be separated from the second position by at least an inch. Further, the link 1 may have a first end attachment point 23, a mid-point pivot axis point 24 pivotably attached to the distal end of the hook arm 2, and a far axis pivot point 25 pivotably attached to the first connector end of the connector 3. Further, the handle 4 may be configured to pivot around the hook arm 2. Further, as discussed elsewhere in the application, the connector 3 may be configured to drive the rotational movement of the link 1. Further, the latch 20 may further comprise an adjustment means for creating a gap 18 between the handle 4 and the connector 3. The gap 18 may be suitable for configuring the latch 20 into the open position from the closed position by means of the handle 4. Further, in said embodiment, the latch 20 may further comprise a safety device 16, wherein the safety is suitable for preventing the latch 20 being operated by means of the handle 4 in the closed position. Further, the adjustment means may include the safety device 16 and the adjustment means may be actuated in the following manner: when the safety hook 5 is disengaged from the rod 15, the latch 20 opens and the gap 18 is created. Once the gap 18 has been created, the latch 20 may be configured to transition to the open position. For example, the handle may be pulled, increasing the size of the gap. In some other embodiments, the safety device 16 may be replaced by a screw-and-nut connection 19.

While the terms “safety hook” and “trigger” are used in the present disclosure, it is contemplated that said terms “safety hook”, “trigger” and may be used interchangeably and are both understood to refer to the same element 5.

While the terms “angle of inclination” and “gap” are used in the present disclosure, it is contemplated that said terms “angle of inclination” and “gap” may be used interchangeably and both refer to the same element 18. Accordingly, said terms refer to a dimension that is adjustable that allows the latch 20 to be configured from the closed position to the open position. The angle of inclination is relative to the size of the components, wherein the larger the components, the smaller an angle of inclination is necessary to produce a gap suitable for configuring the latch into the open position from the closed position.

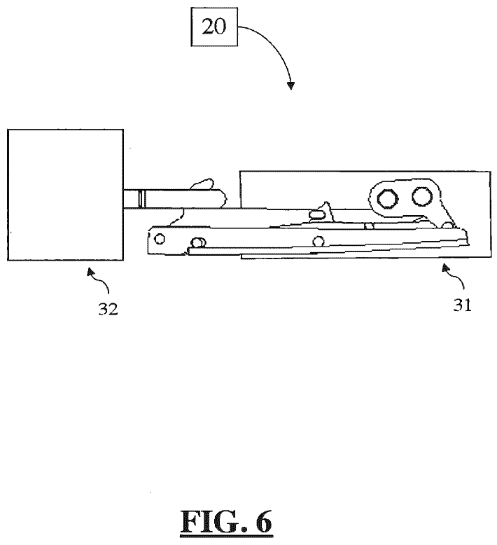

With reference to FIG. 6, an assembly is shown. The assembly comprises a base 31, a door 32 and a latch device 20 configured for holding the door 32 in the closed position relative to the base 31. With continued reference to the figures, the device 20 may comprise a handle 4, and adjustment means 11 for adjusting an angle of inclination 18 of the handle 4 in a closed position of the latch, the adjustment means being controllable from outside the door, and a safety device 16 suitable for preventing the latch being operated by means of the handle 4 and presenting an adjustable dimension. For example, as discussed in more detail elsewhere, the hook latch 20 may include a biasing member positioned between the hook arm 2 and the handle 4. The adjustment means 11 may include the biasing member. The biasing member may be a spring having a first arm sized and shaped to engage the hook arm and a second arm sized and shaped to engage the handle. When the triggers 5 are disengaged from the rods 15, the spring may be configured to exert a force on at least one of the hook arm 2 and the handle 4. This spring may be configured to separate the handle 4 and the hook arm 2 at the angle or inclination 18 and/or gap 18. The exact specifications of the spring may be adjusted to achieve a desired angle of inclination 18 and/or gap 18. Further, the adjustment means are controllable while the door 32 is in the closed position. Further, the latch 20 can be visually determined to be open or closed. While the terms “latch”, “latch device”, and “device” are used in the present disclosure, it is contemplated that said terms “latch”, “latch device” and “device” may be used interchangeably and are both understood to refer to the same element 20.

Due to the structure of the high visibility hook latch 20 of the present disclosure, the visible length thereof is almost double one it is in the open configuration. The increased visibility is achieved with fewer parts and in a simpler fashion as compared to currently existing devices.

There are numerous door members in aircraft that are held by a latch in a predetermined position, e.g. a closed position. These members, referred to herein as “doors” may include, for example, covers, hatches, and/or indeed radomes. The latch may include a main hook 21 suitable for engaging an attachment point that is fastened to a base 31. The base may include a portion of an aircraft. It may also include a handle 4 for operating the hook 21, wherein the handle 4 may be generally accessible through an opening in the door 32. In some embodiment, the handle 4 may be hinged to both the door 32 and also to the hook arm 2.

An outside face of the handle may be visible and accessible through the opening in the door. This face is usually of a plane shape that is sized and shaped to extend flush with the face of the door. Nevertheless, it can happen that when the latch is in the closed position, the outside face of the handle may not extend the outside face of the door, which is generally undesirable for reasons of aerodynamic drag or of appearance. This can be remedied by adjusting the position of the attachment point of the hook. The angle of inclination of the handle in the closed position of the latch depends in particular on the position of the hook on the attachment point. Nevertheless, such an adjustment is difficult to perform: it is necessary to open the door in order to access the attachment point, then to adjust it, then adjust the length of the hook itself by means of a member provided for this purpose on the hook. The distance between the attachment point and the hinge between the hook and the handle has an influence on the force that the operator needs to exert on the handle when closing the latch. Once these operations have been performed, the door may be reclosed and examined to see whether the handle has an appropriate angle of inclination. If it does not, then these operations need to be restarted. As a general rule, these operations will be performed several times, thus making the procedure iterative. In addition, the same operations need to be repeated as many times as there are latches to adjust.

In some embodiments, a latching system is provided for selectively securing a first cowl door with a second cowl door. The latching system includes an anchor secured to the first cowl door and a latch secured to the second cowl door. The latch may include a handle moveable from a closed position to an open position. The latch may further include a gripping arm having a first end configured to couple to the anchor in order to secure the latch to the anchor. The handle may only be moveable to the closed position only when the gripping arm of the latch is secured to the anchor.

It is contemplated that the latching system also includes a biasing element for biasing the gripping arm. In some embodiments the biasing element biases the gripping arm to a position in which the gripping arm of the latch is unsecured to the anchor. It is also contemplated that the handle may be only movable to the closed position when a force exerted by the biasing element is overcome. The biasing element may also be configured to preclude the handle from moving to the closed position unless the latch is secured to the anchor.

It is further contemplated that the latching system may also include a frame having a first aperture, a first end, and a second end. The first end of the frame is preferably pivotably connected to a first end of the handle. The second end of the frame may slidably receive the gripping arm of the latch.

The latching system may also include an actuating member disposed in the handle. The actuating member includes a post configured to extend though the first aperture of the frame. More specifically, the post may only extend through the first aperture of the frame while the handle is being moved to the closed position if the gripping arm of the latch is secured to the anchor. It is contemplated that the post of the actuating member includes a head which is configured to selectively lock the handle in the closed position.

It is also contemplated that the latching system may further include a bracket secured to a second end of the gripping arm of the latch. The bracket may include a second aperture. In such a case, the post may only extend through the first aperture of the frame and the second aperture of the bracket if they are aligned while the handle is being moved to the closed position if the gripping arm of the latch is secured to the anchor.

It is further contemplated that the first aperture of the frame and the second aperture of the bracket are biased to be misaligned. Therefore, the latching system may include a biasing element. The biasing element may be at least one conical spring washer, a compression spring, a compressed gas piston, an elastomer part, a hydraulic piston, or any other similar biasing element. The latching system may also include a tube disposed within the frame. The tube has a closed end and an open end. The closed end of the tube may be secured to the bracket. The open end of the tube may contain a housing that is movable relative to the tube. The housing may also be secured to the second end of the frame.

Furthermore, the gripping arm of the latch may also include a flange disposed between the first end of the gripping arm and the second end of the gripping arm. The flange of the gripping arm of the latch may be disposed within the housing.

It is contemplated that the biasing element may be disposed within the tube between the closed end of the tube and the housing. The biasing element may bias the first aperture of the frame and the second aperture of the bracket into misalignment.

In one or more embodiments, the anchor of the latching system may include a keeper (a component that locks or holds another in place) and a mounting. The keeper may be configured to couple to the first end of the gripping arm of the latch. The mounting may secure the anchor to the first cowl.

It is contemplated that the latching system may also include a shaft which secures the keeper of the anchor to the mounting of the anchor. A distance between the keeper of the anchor and the mounting of the anchor in a direction along an axis of the shaft may be selectively adjustable (see e.g., FIGS. 7A-7C and their respective disclosure below).

It is further contemplated that an adjustment mechanism for adjusting a distance between the keeper of the anchor and the mounting of the anchor in a direction along an axis of the shaft may be provided. The adjustment mechanism may include an aperture with a threaded outer surface

In one or more embodiments, the anchor of the latching system includes a first notched portion and a second notched portion. The first notched portion of the anchor is configured to couple to the first end of the gripping arm of the latch when the handle is being moved to the closed position to exert a closing force from the gripping arm to the anchor in a closing direction. The second notched portion of the anchor may be configured to couple to the first end of the gripping arm of the latch only when the handle is being moved to the open position to transmit an opening force from the gripping arm to the anchor in an opening direction, oppositely orientated from the closing

One or more of the disclosed embodiments provides a device wherein the latching system nay not fully close unless the gripping arm and the anchor are coupled together. Thus, if the two are uncoupled, the handle will remain in at least a partially open position, making it easier to visually determine if the latching system is indeed properly closed-and thus if the cowl doors are secured together and fully closed.

Furthermore, one or more of the embodiments provide a latching system that ensures application of a nominal clamping stress between the two cowl doors. If the appropriate force is not present because the latching system is not properly secured, the latching system cannot be fully closed. Such a latching system further increases the ability to visually determine the status of the latching system as well as the two cowl doors.

Additionally, one or more of the disclosed embodiments provides a device with an actuating member that locks the handle in the closed position. This is believed to be beneficial and desirable because it ensures that the cowl doors are properly closed and locked under a nominal stress of clamping during the phases of flight and that the handle will not open and the latch will not decouple from the anchor until the actuating member is released.

Finally, one or more of the disclosed embodiments provides a latching system with an anchor having two portions configured to couple to the gripping arm. It is believed that such a design, along with a movement of the handle and pivot arms, better facilitates separation of the two cowl doors and allows for easier opening and closing of the cowl doors for light maintenance operations without the use of inappropriate tools that may damage the cowl doors or other systems and related components.

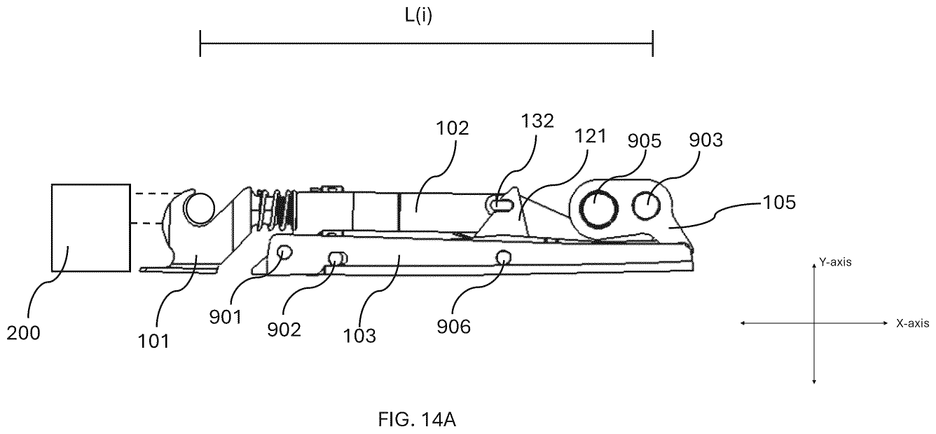

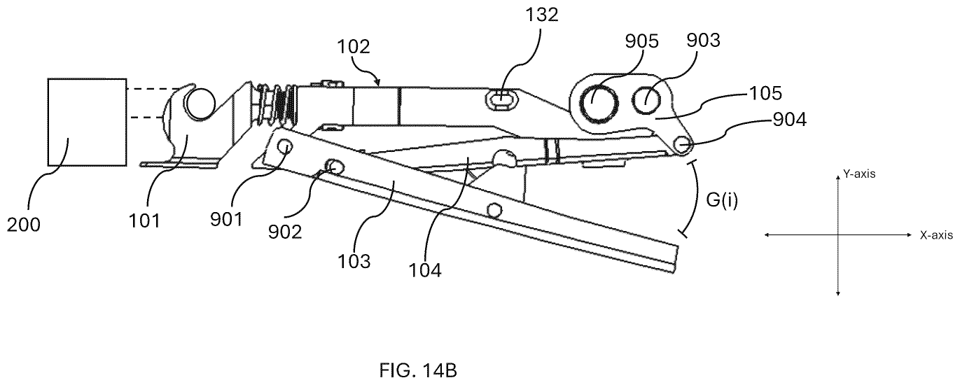

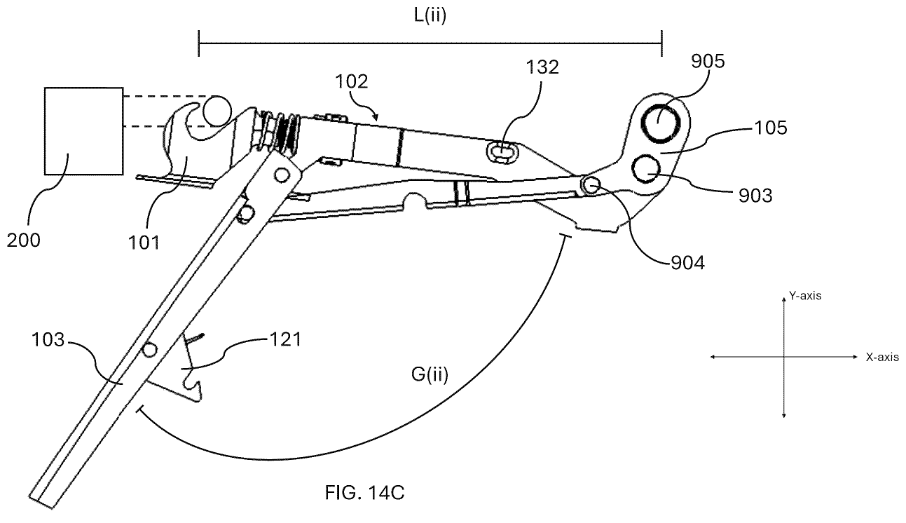

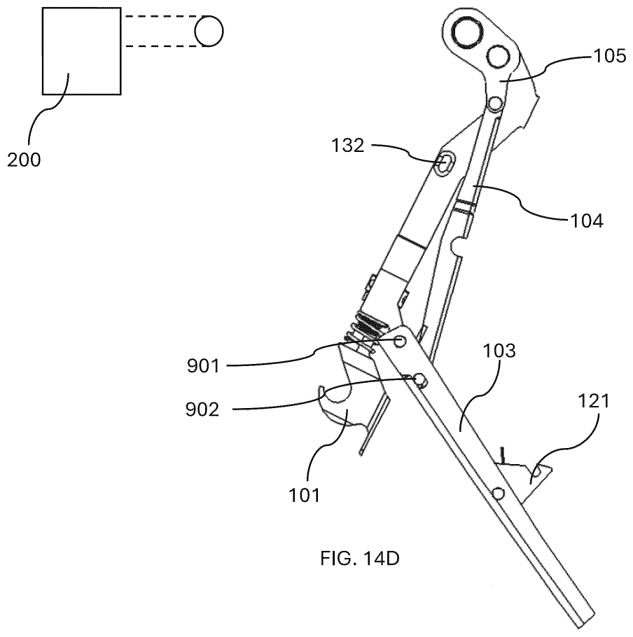

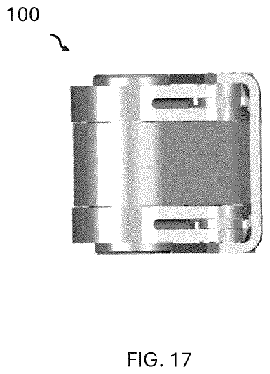

FIGS. 7A-21 show additional illustrations of the described embodiments. As illustrated in FIGS. 7A-7C, a hook latch 100 may include a hook arm, a first elongate member (e.g., handle 103), a second elongate member (e.g., connector 104), a link 105, and four pivot points (e.g., depicted with circles). The hook arm and the first elongate member (e.g., handle 103) may be connected at a first pivot point (e.g., circle 901—FIGS. 14A-14D). The first elongate member (e.g., handle 103) and the second elongate member (e.g., connector 104) may be connected at a second pivot point (e.g., circle 902—FIGS. 14A-14D). The hook arm and the link 105 may be connected at a third pivot point (e.g., circle 903 - FIGS. 14A-14D). The second elongate member (e.g., connector 104) and the link 105 may be connected at a fourth pivot point (e.g., circle 904—FIGS. 14A-14D). Accordingly, at least one of the first elongate member and the hook arm are configured to at least partially pivot around the first pivot point, at least one of the first elongate member and the second elongate member are configured to at least partially pivot around the second pivot point, at least one of the link 105 and the hook arm are configured to at least partially pivot around the third pivot point, and at least one of the link 105 and the second elongate member are configured to at least partially rotate around the fourth pivot point. Finally, the hook latch 100 may further include a fifth pivot point (e.g., circle 905—FIGS. 14A-14D), wherein the hook latch 100 as a whole may pivot around the fifth pivot point. The fifth pivot point may be where the hook latch 100 is coupled or otherwise attached to plane.

As can be seen by comparing FIGS. 1-6 and FIGS. 7A-17, many of the individual components share at least some similarities to each other. Accordingly, discussion of particular aspects, components, or combination of components for the embodiments illustrated in FIGS. 1-6 also applies to FIGS. 7A-17.

The design allows for the hook latch 100 to transition from a compact and relatively small, aerodynamic configuration to an expanded and relatively large and visible configuration. Since the folded and/or collapsed configuration is relatively small, this allows for the hook latch 100 to be fitted onto a greater variety of planes. For example, planes, engines, and nacelles are designed and built in different shapes and sizes. Due to this variety, the amount of space available to position a hook latch 100, or the available amount of space available to allow specific parts to rotate or otherwise move within the plane will vary based on the plane. Since hook latches 100 of the present disclosure can fold into a relatively compact and small volume and require less space and/or clearance to transition from the folded configuration to the unfolded configuration, hook latches 100 described herein can be incorporated into a variety of planes (e.g., a user does not need to design a plane around this hook latch 100, the hook latch 100 can be retrofitted onto a variety of pre-existing and/or pre-built planes). Additionally, or alternatively, the ability of the hook latch 100 to expand and/or contract from a folded and/or unfolded configuration allows for increased visibility of the hook latch 100.

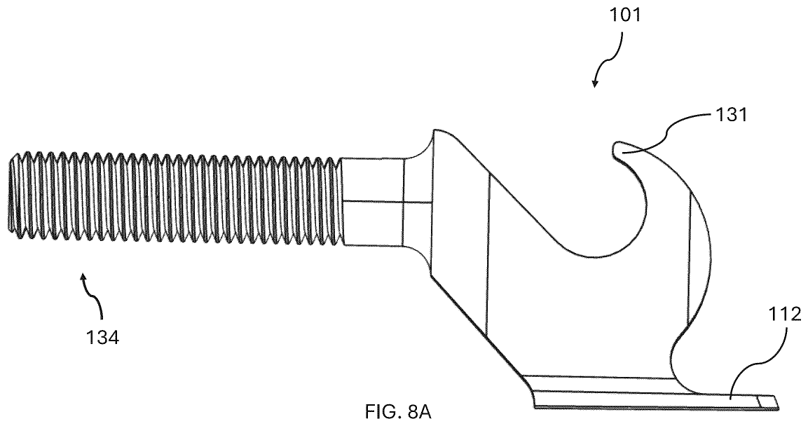

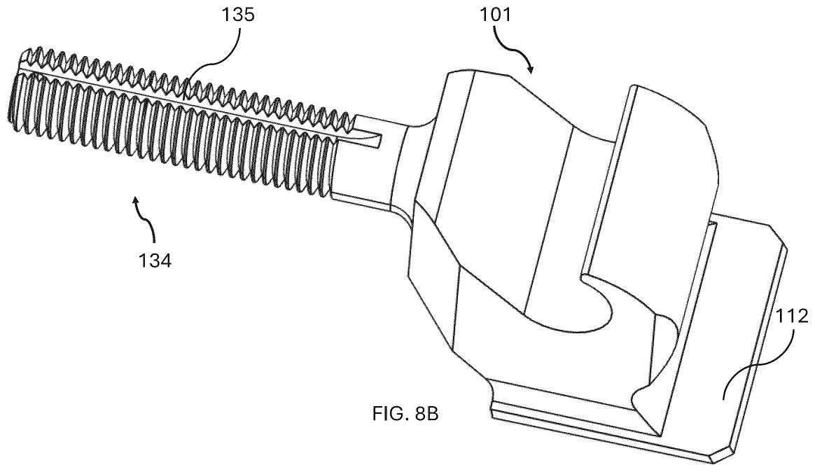

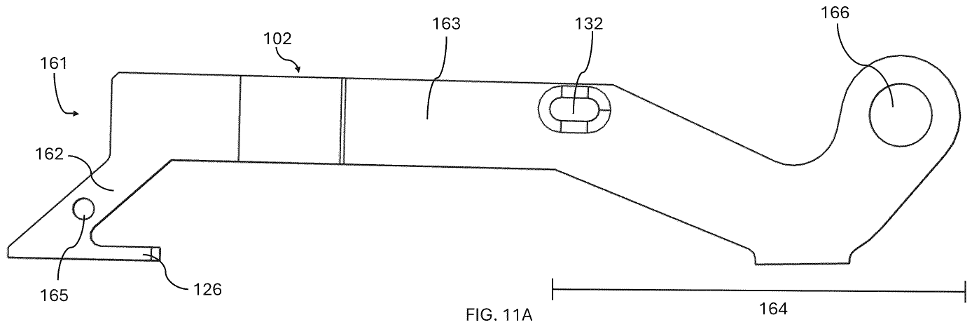

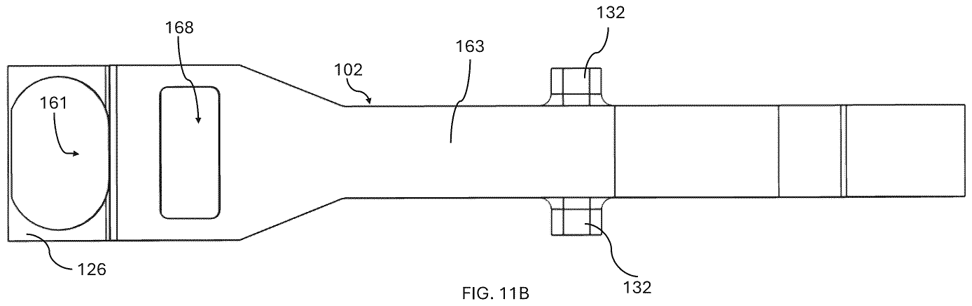

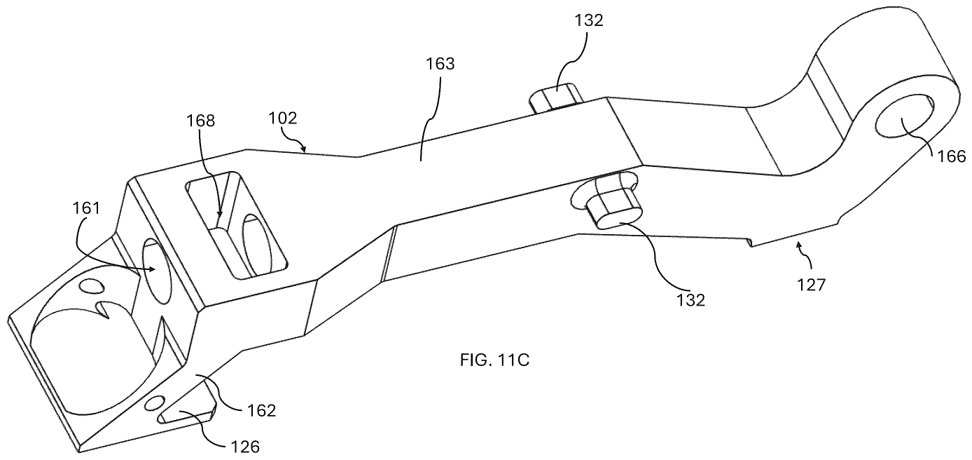

The hook arm may comprise a hook portion 101 (see FIGS. 8A-8B) and an elongate arm portion 102 (see FIGS. 11A-11C). The hook portion 101 may couple with the elongate arm 102 portion. Turning to FIGS. 8A-8B, the hook portion 101 may include a distal portion (toward the hook side) and an opposite proximal portion. The distal portion may comprise a hook configured to engage or otherwise couple with a clevis 200 of an airplane (see FIGS. 14A-14D). In some embodiments, the distal portion may also include a platform 112 extending from the bend or shank of the hook. The platform 112 may have a substantially quadrilateral shape. As will be described in more detail elsewhere in the application, the platform 112 may be substantially planar and configured to reduce a gap between the distal most end of the hook (a hook/anchor end as opposed to a link 105 or tail end) and the airplane. For example, the platform 112 can act as an aerodynamic cover for an opening sized to receive or accommodate the hook 101.

In some embodiments, the hook also includes a male portion 134 extending from the hook. The male portion 134 may be generally cylindrically shaped. In some embodiments, at least a portion of the male portion 134 comprises one or more threads extending along a length of the male portion 134. Additionally, or alternatively, the male portion 134 may include a recess 135 extending through at least a part of the threaded portion. In some embodiments, the recess 135 may extend beyond the threaded portion and may form a notch or groove.

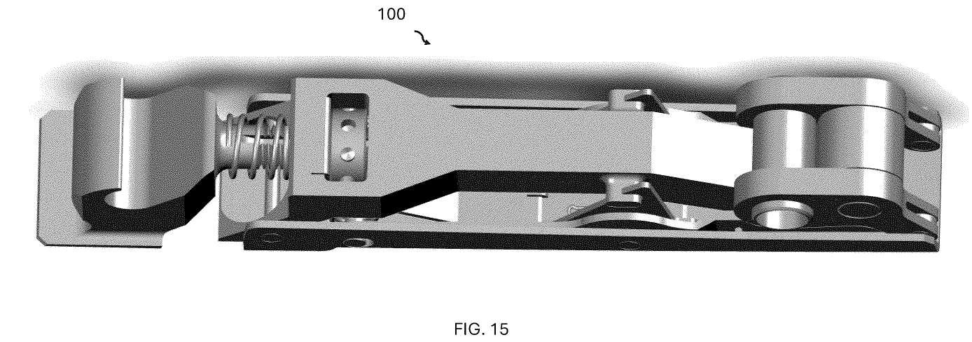

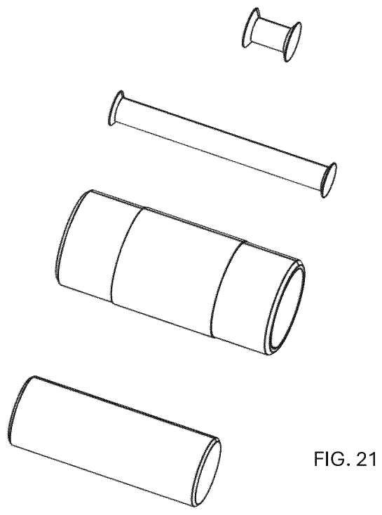

Turning now to FIGS. 11A-11C, the hook arm may further comprises an elongate arm 102. In some embodiments, the elongate arm 102 may include a female portion 161 having a cavity 123 (see FIG. 7C) configured to receive or accommodate the male portion 134 of the hook portion 101. Additionally, or alternatively, the elongate arm 102 may include an elongate portion 163 having the female portion 1614, and a canted portion 164. The elongate portion 163 may define a longitudinal axis A (see FIG. 7A), and the canted portion 164 may initially extend away from the longitudinal axis A then extend towards the longitudinal axis A, forming a groove. As will be discussed in more detail elsewhere, this groove may be configured to receive or accommodate a rod, pin, pin assembly, or struts extending through a first end pivot point 141 of the link 105 (see e.g., FIG. 7A-7C and 15). As will be discussed elsewhere, this groove can be configured to receive the rod or the like connecting the hook latch 100 to the aircraft and can allow for the hook latch 100 to have a compact organization and/or profile when the hook latch 100 is in the folded configuration while still allowing for all the respective components to rotate around their respective pivot points to transition to the unfolded, expanded configuration. In some embodiments, the canted portion 164 may have a generally hockey stick shape and/or a L-Shape. As illustrated in FIGS. 11A-11C, the canted portion 164 may have a planar surface 127 (see FIG. 7D). This planar surface 127 may be inserted into a second window of the handle 103 described below. Additionally, or alternatively, the elongate arm 102 may further comprise a second platform 126. The second platform 126 may be positioned radially away from the longitudinal axis A such that the planar surface is located below the elongate portion 163. The second platform 126 can further fill a gap and provide an aerodynamic benefit as described above with respect to the first platform 112. In some embodiments, the elongate portion 163 further comprises struts 162 configured to connect the elongate portion 163 to the second platform 126. The proximal end (e.g., a link 105 end) of the canted portion 164 may include a window configured to receive a rod, pin assemblies, and/or strut. The rods, pin assemblies, and/or struts can be generally similar to the rods, pin assemblies, and/or struts illustrated in FIGS. 20 and 21. For example, the rods, struts, and/or pin assemblies may be hollow tubes. Additionally, or alternatively, the rods, struts, and/or pin assemblies may be solid tubes without cavities. Additionally, or alternatively, the rods, struts, and/or pin assemblies may include one or more enlarged heads having diameters larger than the diameters of the shank and/or main body. Some rods, pin assemblies, or struts may include a portion (e.g., a middle portion) with a diameter greater than at least one of a first end or a second end. Additionally, or alternatively, the rods, struts, and/or pin assemblies may comprise a male pin 221 configured to be at least partially inserted into a female pin 222, and a sleeve 223 configured to be positioned over at least one of the male pin and the female pin.

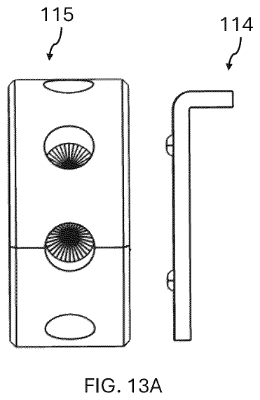

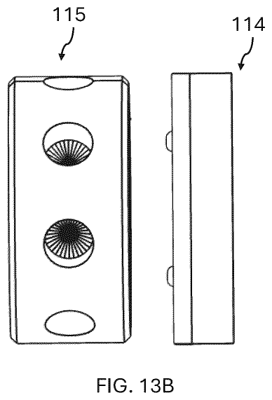

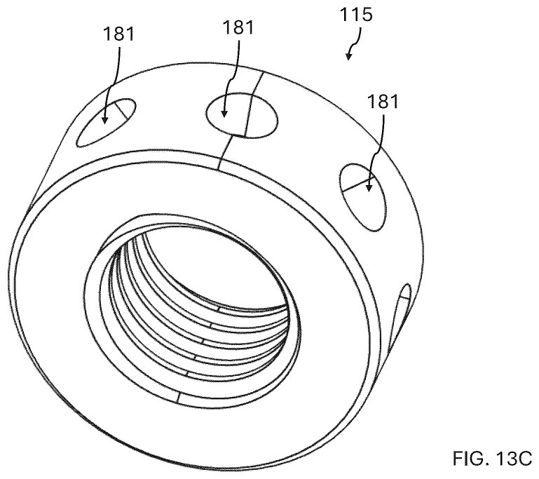

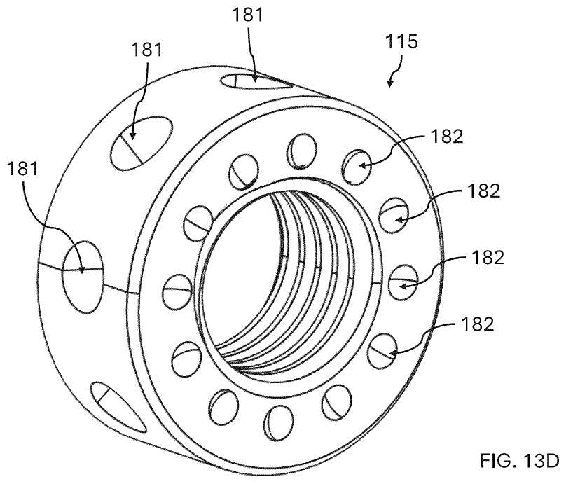

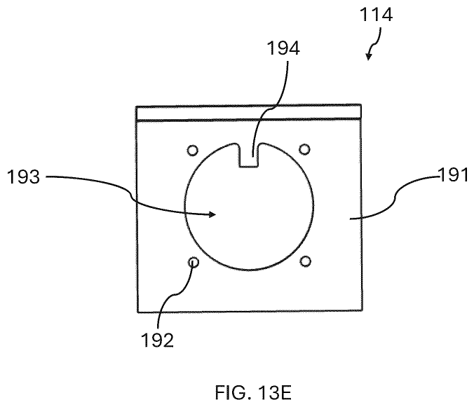

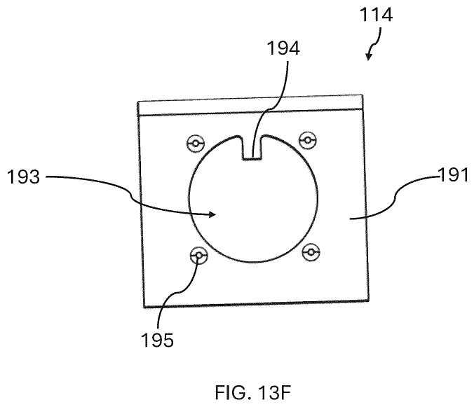

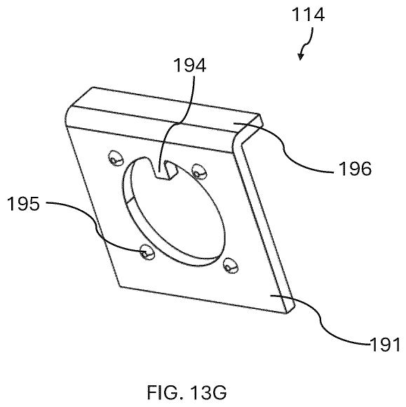

In some embodiments, the elongate portion 163 may include a narrow portion and a wide portion. In some embodiments, the narrow portion gradually flares outward. Additionally, or alternatively, the wide portion may include one or more windows 168 (e.g., a first window on a first side and a second window on a second side). Accordingly, additional components may be inserted into the one or more windows 168. For example, an adjustable nut 115 and/or a hook stabilizer 114 (FIGS. 13A-13G) may be placed into the one or more windows 168.

As illustrated in FIGS. 13C-13D, a nut 115 may be generally cylindrical having a central cavity and a threaded interior. The central cavity may be configured to receive or accommodate the male portion 134 of the hook portion 101 (See FIGS. 7A-7C). In some embodiments, the threaded interior may be configured to threadedly engage the threaded portion of the male portion 134 of the hook portion 101. Further, a curved surface of the adjustable nut 115 may include one or more notches 181. In some embodiments, the curved surface of the adjustable nut 115 may comprise a plurality of notches 181, which may be circumferentially and/or equally spaced from one another. The one or more notches 181 may be configured to receive or accommodate a pin or other tool to facilitate rotation of the nut. Additionally, or alternatively, a circular base of the adjustable nut 115 may include one or more notches 182. In some embodiments, the circular base of the adjustable nut 115 may comprise a plurality of notches 182, which can be circumferentially and/or equally spaced. When the adjustable nut 115 is threadedly engaged with the threaded portion of the male portion 134, the adjustable nut 115 can be configured to rotate by a user's hand (e.g., a users bare hand or a gloved hand). However, the one or more notches 181 in the curved surface may be configured to receive a pin or other tool configured to facilitate the rotation of the adjustable nut 115.

Turning now to FIGS. 13E-G, the hook arm may further include a hook stabilizer 114. The hook stabilizer 114 may include a sheet 191 with a window 193. Although the hook stabilizer 114 is illustrated as having a generally rectangular shape, the hook stabilizer 114 can have any shape (e.g., triangular, circular, pentagonal, hexagonal, etc.). Further, the window 193 may be configured to receive the male portion 134 of the hook portion 101. Additionally, or alternatively, the hook stabilizer 114 may include a projection 194 extending into the window 193. For example, the projection 194 may extend toward an epicenter of the window 193. The projection 194 may be configured to engage the recess 135 of the male portion 134 of the hook portion 101 (FIG. 8B). Accordingly, when the projection 194 engages the recess 135, if the hook rotates, the projection 194 would engage elevations of the threaded portion, or vice versa. Additionally, or alternatively, the sheet 191 may include a first side and a second side. The first side of the sheet 191 may be substantially planar. However, the first side may include indentations or notches 192 due to manufacturing processes. The second side of the sheet 191 may have one or more protrusions 195 configured to engage the one or more notches 182 of the circular base of the adjustable nut 115. In some embodiments, the hook stabilizer 114 may further comprise a flange 196 or cantilever. When the hook stabilizer 114 is positioned within the one or more windows 168 (see FIGS. 11B, 11C) of the elongate arm 102, the flange 196 is configured to engage at least a portion of the elongate arm 102, inhibiting the hook stabilizer 114 from falling through the one or more windows 168.

As illustrated in FIGS. 7A-7C, a fully assembled hook arm may include the hook portion 101, the elongate arm 102, a biasing member 113, the adjustable nut 115, and the hook stabilizer 114. The biasing member 113 can comprise a spring, having a central cavity. The male portion 134 of the hook portion 101 may at least partially extend through the female portion 161 of the elongate arm 102, the window of the hook stabilizer 114, the cavity of the adjustable nut 115, and the central cavity of the spring. Accordingly, when the hook arm is assembled, the spring exerts a biasing force on the hook along the longitudinal axis A (see FIG. 7A) and/or away from the elongate arm 102. Additionally, or alternatively, the projection 194 of the hook stabilizer 114 engages the recess 135 of the male portion 134, and the one or more protrusions 195 of the hook stabilizer 114 may engage the one or more notches 182 of the circular base of the adjustable nut 115. The threaded interior of the adjustable nut 115 threadedly engages at least a portion of the threaded portion of the male portion 134. Accordingly, although the spring is exerting the biasing force away from the elongate arm 102, at least one of the hook stabilizer 114 and the adjustable nut 115 inhibits or prevents the hook portion 101 from moving along the longitudinal axis A and/or rotating.

Additionally, or alternatively, the hook arm described above may be configured to transition from an extended configuration to a reduced configuration. For example, the assembled hook arm may have a length extending from a proximal end (e.g., a link 105 end) to a distal end (e.g., a hook/anchor end). The hook arm may have a first length when the hook arm is in the reduced configuration, and the hook arm may have a second length when the hook arm is in the extended configuration. The second length may be larger than the first length.

In some embodiments, the hook arm may transition from the reduced configuration to the extended configuration (and/or vice versa) by rotating the adjustable nut 115. For example, when the adjustable nut 115 is threadedly engaged with the threaded portion of the male portion 134, rotation may cause the hook portion 101 to move along the longitudinal axis A. In some embodiments, the biasing member 113 or spring positioned between the hook and the female portion 161 may facilitate this movement along the longitudinal axis A. Additionally, or alternatively, when the projection 194 of the hook stabilizer 114 engages the recess 135 of the male portion 134 (see FIG. 8B), the hook is inhibited from rotating (e.g., about the longitudinal axis A). However, the projection 194 moves relative to the threads along the length of the recess 135 and allows the male portion 134 to extend or retract along the axis A, thereby allowing for the tip 131 to extend out farther or retract closer to the elongate arm 102. For example, when the adjustable nut 115 rotates, the projection 194 of the hook stabilizer 114 engages the sides of the recess 135 as it passes through, and deeper than, the threaded portions, inhibiting the hook from rotating while it passes along a portion of the elongate recess 135. Accordingly, when the adjustable nut 115 rotates, the hook portion 101 remains in the same rotational orientation but extends longer or shorter along axis A while the adjustable nut 115 rotates. One benefit of this assembly is that a user does not have to wait for the hook to be in a desired rotational position (e.g., when the hook portion 101 faces upwards to engage a clevis in an airplane surface, as opposed to sideways or otherwise unable to engage such a clevis). Another benefit of this hook arm assembly is the ease with which a hook latch 100 having this assembly can be retrofitted onto a variety of aircraft. For example, some hook arms have fixed dimensions such as lengths. Thus, such fixed-length hook arms can only be efficiently used in aircrafts that require hook latches 100 with that specific length. Accordingly, the size of the fixed-length hook latch 100 has to be designed for a specific aircraft or an aircraft has to be designed around a specific sized hook latch 100. In contrast, the length of the hook arm assemblies described herein can be adjusted as described above. Accordingly, if an airplane requires a hook latch 100 with a length of 2.5 feet, the hook latches 100 described herein can be adjusted such that the length of the hook latch 100 is 2.5 feet. Additionally, or alternatively, if an airplane requires a larger or smaller hook latch 100, the length of the hook latches 100 described herein can be adjusted to accommodate the larger or smaller length requirement. Accordingly, adjustable-length latches have many benefits for flexibility, retrofitting and efficient installation.

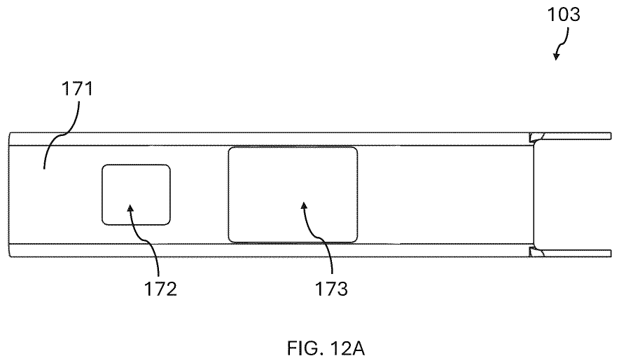

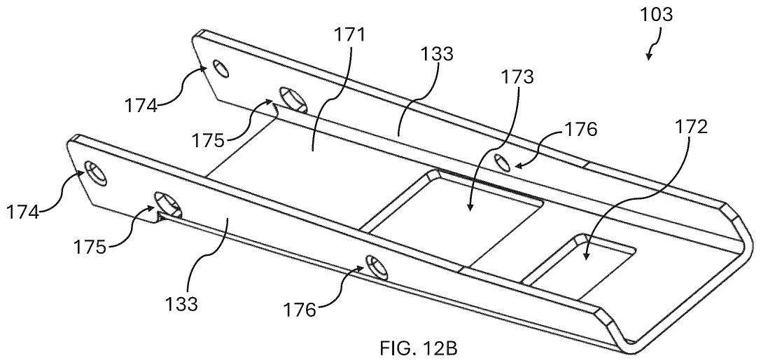

Turning now to FIGS. 12A and 12B, the hook latch 100 may include a first elongate member. The first elongate member can comprise the handle 103 depicted in FIGS. 12A and 12B. The handle 103 can include an elongate base plate 171 and one or more walls 133 extending from the base plate 171. In some embodiments, the elongate base plate 171 may include a first elongate side and a second elongate side, and the one or more walls 133 may extend from the first elongate side and/or the second elongate side. In some embodiments, the walls 133 may extend generally perpendicular from the base plate 171. Additionally, or alternatively, a portion of the walls 133 may extend beyond the elongate sides of the base plate 171. The walls 133 may also have one or more apertures, which can occur in corresponding sets or pairs, for example. These corresponding apertures may be configured to receive or accommodate pins, struts, rods, or the like. These pins may provide the pivot points described elsewhere in the application. In some embodiments, each wall 133 has a plurality of apertures that correspond to aligned apertures in an opposite wall, such that a rounded pin or rod or the like can extend through both aligned apertures. In some embodiments, each wall 133 includes three corresponding apertures (e.g., a first aperture 174, a second aperture 175, and a third aperture 176). These apertures (e.g., the first aperture 174, the second aperture 175, and the third aperture 176) may be generally circular or rounded, which can facilitate rotation or pivoting. At least one of these apertures may may have a non-circular shape. For example, as illustrated in FIGS. 7A and 12B, the second aperture 175 may have an oblong shape or an elongated shape. As illustrated in a comparison of FIGS. 14A and 14B, a pin, rod, or strut may shift from a first side of the aperture to a second side of the aperture. This ability to shift from one side of the aperture to another facilitates the ability of the hook latch 100 to transition from the folded configuration to the unfolded configuration, while maintaining the compact and tightly organized folded configuration. Additionally, or alternatively, this non-circular shape may allow for the handle 103 to be lifted slightly towards the hook arm to facilitate a locking assembly transitioning from a locked configuration to an unlocked configuration. Accordingly, a rounded elongate opening can allow multiple degrees of freedom for a pin or rod extending therethrough, allowing, at times or in turn, rotational and translational movement.

As noted above and illustrated in FIG. 11A, the elongate arm 102 may include one or more struts connecting the female portion 161 to the platform 126. The one or more struts 162 may include one or more apertures 165. The apertures 165 in the elongate arm 102 may be aligned with the first aperture 174 of the handle 103 (FIG. 12B). A pin assembly or rod (see e.g., FIG. 21) may be inserted through the first aperture(s) 174 of the handle 103 and the apertures 165 of the female portion 161, coupling the hook arm to the handle 103.

In some embodiments, the base plate 171 may include one or more windows 172, 173 (See FIG. 12A) to receive or accommodate various other portions of the hook latch assembly 100. In certain embodiments, the base plate 171 may have a first window 173 and a second window 172. As will be described elsewhere in the application, the first window 173 may be configured to receive a portion of a locking assembly or a safety assembly. The second window 172 may be configured to receive a portion of the hook arm. For example, the second window 172 may be configured to receive the canted portion 164 of the hook arm (FIG. 11A) when the hook latch 100 is in a folded or collapsed configuration.

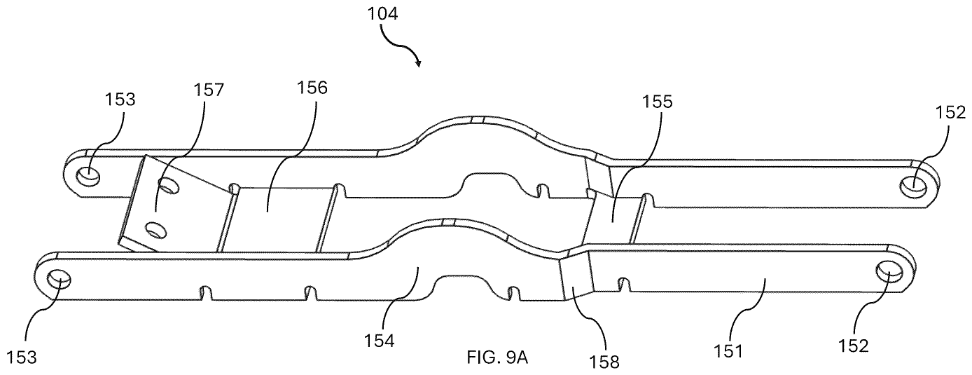

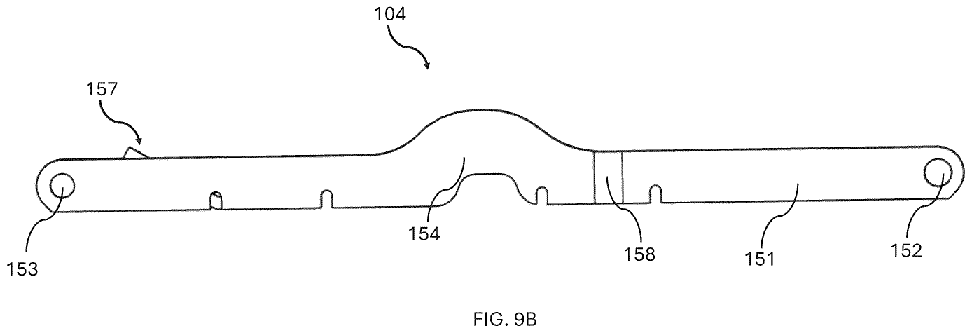

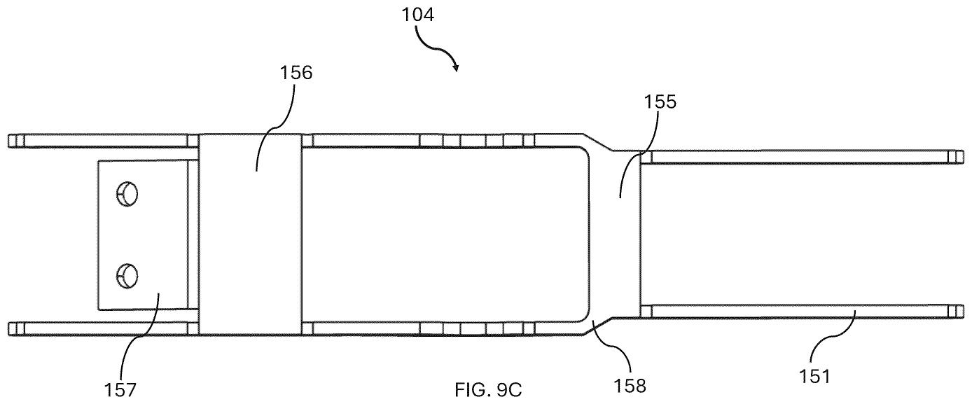

Turning now to FIGS. 9A-9C, the hook latch 100 may include a second elongate member. The second elongate member may comprise the connector 104 depicted in FIGS. 9A-9C. The connector 104 may comprise one or more elongate struts 151. In some embodiments, the connector 104 may comprise two elongate struts 151 connected by one or more bridges (e.g., a first bridge 156 and a second bridge 155) or platforms. The one or more elongate struts 151 may include a first end (e.g., a handle 103 end) and a second end (e.g., a link 105 end). At least one of the first end and the second end may include an aperture 152, 153 (and/or corresponding apertures if there are two elongate struts 151). In some embodiments, both the first end and the second end of the one or more struts include apertures 152, 153. These apertures 152, 153 and/or corresponding apertures may be configured to receive pins, struts, rods, or the like. For example, the apertures 153 of the first end of the connector 104 may be aligned with the second apertures 175 of the handle 103 (FIGS. 12A-12B). A pin assembly or rod (see e.g., FIG. 21) may be inserted through the second aperture(s) 175 of the handle 103 and the first aperture 153 of the connector 104, coupling the connector 104 to the handle 103.

The one or more struts may be aligned along a longitudinal axis A (see FIG. 7A). In some embodiments, the connector 104 comprises two elongate struts 151 extending in a direction generally parallel to the longitudinal axis A. In some embodiments, the elongate struts 151 may include a transition portion 158 where the elongate struts 151 taper inwards towards the longitudinal axis A. In some embodiments, this tapered portion 158 is present to allow the connector 104 to couple with the link 105 or link 105s, but still allowing for the connector 104 and links 105 to be nested within the handle 103 when the hook latch assembly 100 is in the folded configuration (See e.g., FIGS. 7B, 15, and 17). Additionally, or alternatively, the elongate struts 151 may comprise an arched portion 154 wherein the elongate struts 151 elevate, forming a bump or bridge. In some embodiments, the arch portion 154 comprises a corresponding cavity. As will be discussed in more detail elsewhere, the cavity may be configured to receive or accommodate a pin or strut. Thus, when the hook latch 100 transitions from an unfolded configuration to a folded configuration (or vice versa), pins or struts of other components do not engage the connector 104. Instead, the pin or rod or strut is received within or accommodated by the cavity.

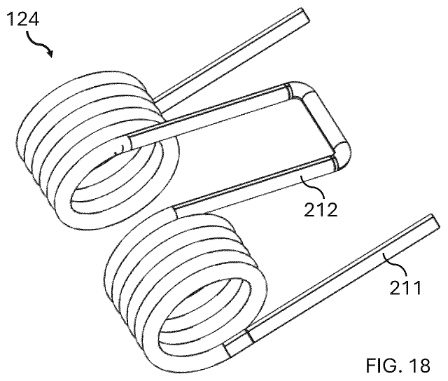

In certain other embodiments, the connector 104 may further comprise a support platform 157 extending from a first bridge 156. In some embodiments, the support platform 157 extends from a first bridge 156 at a first angle such that the first bridge 156 and the support platform 157 form an obtuse angle. As illustrated in FIG. 7C, the hook latch assembly 100 may include the handle 103 coupled to the connector 104. The hook latch assembly 100 may further comprise a biasing member 124 positioned between the handle 103 and the connector 104. The biasing member 124 may be a spring such as a torsion spring. The spring may have a central cavity and two or more arms. The central cavity may be configured to receive a rod connecting the handle 103 to the connector 104. A first arm 211 of the spring may be configured to engage the base plate 171 of the handle 103, and a second arm 212 of the spring may be configured to engage the support platform 157 of the connector 104. Accordingly, the spring may be configured to exert a biasing force on at least one of the handle 103 and the connector 104 such that the hook latch 100 is biased towards an unfolded configuration. In some embodiments, the spring exerts a biasing force where the respective arms contact the connector 104 and the handle 103. Accordingly, the contacted regions are biased away from each other. The biasing member 124 may be generally similar to the spring depicted in FIG. 18.

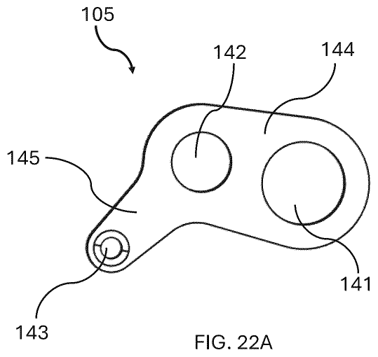

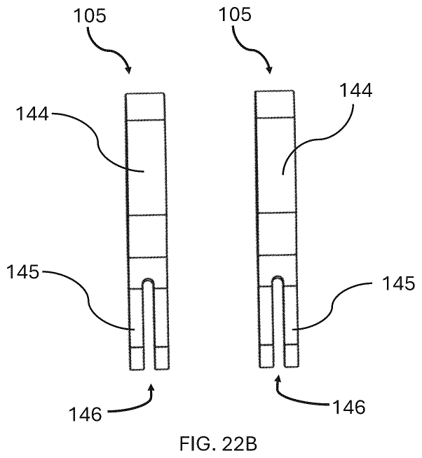

Turning now to FIGS. 22A and 22B, the hook latch assembly 100 may include a link 105. The link 105 may include a first end attachment point, a mid-point attachment point, and a second end attachment point. The hook arm may be pivotably attached to the link 105 at mid-point attachment point. Additionally, or alternatively, the connector 104 may be pivotably attached to the link 105 at the second end attachment point. Additionally, or alternatively, the link 105 may be pivotably attached to the plane at the first end attachment point. As illustrated, the link 105 has a shape configured to provide a maximum reach of the hook latch 100. For example, a main body of the link 105 may have an egg shape, or a generally elongate egg shape (e.g., a first end of the main body having a greater width than a second end of the main body). In certain other embodiments, the link 105 may have a generally oval shape. The link 105 may include a protrusion 145 extending from one end of the main body 144. The protrusion 145 and the main body 144 may form a groove or bend where they come together. In some embodiments, the mid-point attachment point may be positioned in the narrower portion of the main body of the link 105. Additionally, or alternatively, the second end attachment point may be positioned in the protrusion 145 of the link 105. Additionally, or alternatively, the first end attachment point may be positioned in the wider portion of the main body of the link 105. Accordingly, the first end attachment point may be aligned along a first axis, and the second end attachment point is unaligned from the first axis. In certain embodiments, the link 105 can have a generally L-shape and/or a generally hockey stick shape.

In some embodiments, the attachment points (e.g., the first end attachment point, the mid-point attachment point, and the second end attachment points) correspond to a pair of aligned apertures in the link 105. As illustrated in FIG. 22B, the protrusion 145 extending from the main body of the link 105 may have a recess 146 bisecting the protrusion 145, e.g., in the form of a slot. In some embodiments, one of the ends of the connector 104 (e.g., the first end or the second end) may be inserted into the recess 146 of the link 105. Accordingly, the second end attachment point may be aligned with the apertures 152 of the connector 104. Additionally, a strut, pin assembly, or rod (see e.g., FIG. 21) may be inserted through the second end attachment point and the apertures of the connector 104, coupling the connector 104 to the link 105.

Additionally, or alternatively, the hook latch assembly 100 may comprise two corresponding links 105 having corresponding mid-point attachment points. In some embodiments, the aperture of the canted portion 164 of the elongate arm 102 may be aligned with the corresponding mid-point attachment points. A pin assembly or rod (see e.g., FIG. 21) may be inserted through the corresponding mid-point attachment points and the aperture of the canted portion 164, coupling the hook arm to the link 105.

As will be described in more detail elsewhere in the application, the hook latch assemblies 100 described herein may be configured to transition from a folded configuration to an unfolded configuration. The hook latch assembly 100 may comprise one or more biasing members 124 configured to bias the hook latch assembly 100 towards the unfolded configuration. In some embodiments, the hook latch 100 may further comprise a locking a locking assembly configured to transition from a locked configuration and an unlocked configuration. The locking assembly may also be configured inhibit or prevent the hook latch assembly 100 from transitions from the folded configuration to the unfolded configuration when the locking assembly is in the locked configuration. The hook latch assembly 100 may be permitted to transition from the folded configuration to the unfolded configuration when the locking assembly is in the unlocked configuration.

The locking assembly may comprise the button 116 depicted in FIGS. 10A-10C. The button 116 may comprise a contact plate and one or more locking arms 121 extending from the button 116. The one or more locking arms 121 may extend generally perpendicularly from the contact plate. In some embodiments, the button 116 may include two locking arms 121 on opposite sides of the contact plate. The locking arms 121 may include corresponding eyelets 255 configured to receive pin assembly, struts, and/or rods. For example, the eyelets 255 of the one or more locking arms 121 may be aligned with the third apertures 176 of the handle 103. A pin assembly or rod (see e.g., FIG. 21) may be inserted through the eyelets 255 of the locking arms 121 and the apertures of the handle 103, coupling the handle 103 to the button 116, and forming a pivot point. Accordingly, the button 116 may pivot about this pivot point. As illustrated in FIG. 7D, the contact plate of the button 116 may be positioned within the second window of the handle 103. Thus, a user may be able to press the button 116 through the second window. Additionally, the contact plate may further include a flange 251 or projection configured to contact the handle 103 and inhibit movement of the contact plate through the second window.

The one or more locking arms 121 may include one or more projections 253 and one or more corresponding recesses 252. As illustrated in FIGS. 11A-11C, the elongate arm 102 of the hook arm may comprise protrusions 132 extending out of sides of the hook arm. When the locking assembly is in the locked configuration, the protrusions 132 of the hook arm engage the locking arms 121 or are inserted into the recesses 252 of the locking arms 121, inhibiting or preventing the hook latch 100 from transitioning to the unfolded configuration. When the locking assembly is in the unlocked configuration, the protrusions 132 of the hook arm are disengaged from the locking arms 121 or are withdrawn from the recesses 252 of the locking arms 121. In some embodiments, the locking assembly transitions from the locked configuration to the unlocked configuration when the contact plate of the button 116 is pressed. This causes the button 116 and the locking arms 121 to pivot about the pivot point, causing the locking arms 121 to disengage from protrusions 132 of the hook arm. Thus, the locking arms 121 may be configured to rotate from a first position to a second position. The locking arms 121 may rotate about an axis created by a pin, rod, or strut extending through the eyelets 255 of the locking arms 121. When the locking arms 121 rotate about the axis towards the second position, the locking arms 121 disengage from the protrusions 132 of the hook arm, and the locking assembly swivels to an unlocked configuration. As illustrated in FIG. 7C, the locking assembly may include a biasing member 125 configured to bias the locking assembly towards the locked configuration. For example, the biasing member 125 may comprise a spring having a central cavity configured to receive the pin assembly or rod, a first arm 214 (or pair of arms—see FIG. 19) configured to engage the contact plate, a second arm 215 (or pair of arms—see FIG. 19) configured to engage the hook arm, and a third arm 213 (or pair of arms—see FIG. 19) configured to engage the handle 103 and/or the second bridge 155 of the connector 104. Accordingly, the biasing member 125 may exert a force on the button 116 and the hook arm, pushing the contact plate downward away from the hook arm, and biasing the locking assembly towards the locked configuration. The biasing member 125 may be generally similar to the spring depicted in FIG. 19.

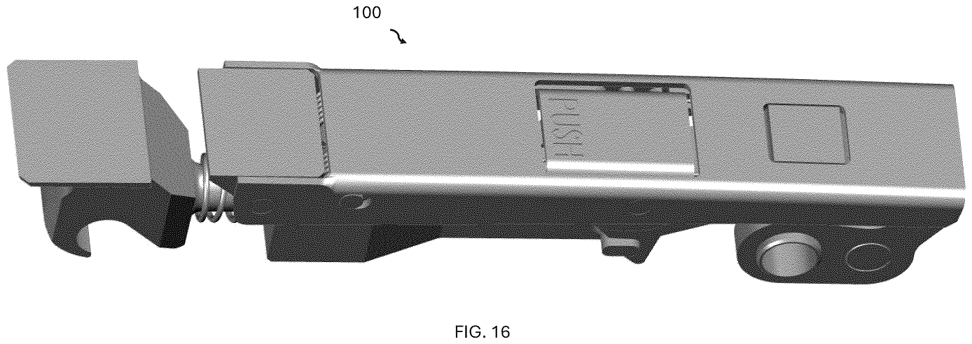

Turning now to FIGS. 7A-7D and 15-17, the hook latch assemblies 100 described herein can be very compacted, nested assemblies (see e.g., FIGS. 14A and 15-17). As illustrated in FIGS. 7A-7D and 15-17, when the hook latch assembly 100 is in the collapsed or compacted configuration, at least some of the components are nested within the handle 103. The hook arm, connectors 104, button 116, and links 105 may be positioned radially within the walls 133 of the handle 103 (See FIGS. 12A and 12B). Accordingly, any aircraft that can accommodate the width of the handle 103 may be able to accommodate the hook latch assembly 100. Additionally, when the hook latch 100 is assembled and in the folded or collapsed configuration illustrated in FIGS. 15-17, an exterior surface may be exposed to ambient when the hook latch 100 is fitted to an aircraft. The exterior surface may include at least one of the platform 112 of the hook portion 101, the platform 126 of the female portion 161, the handle 103, the contact plate of the button 116, and the 127 (see FIG. 7D) of the canted portion 164 of the hook arm (See FIG. 7D). The exterior surface may be generally or substantially contiguous with adjacent portions or parts of the aircraft. As seen particularly in FIG. 16, there may be a gap between the platform 112 of the hook portion 101 and the platform 126 of the female portion 161. The smaller the gap, the more contiguous the exterior surface. A more contiguous surface is a more aerodynamically efficient aircraft. Accordingly, using the hook arm adjustment assembly described herein, the length of the hook arm may be adjusted such that the hook can still engage a clevis 200 of an aircraft and minimize the cap between the platform 112 of the hook portion 101 and the platform 126 of the female portion 161.

Turning now to FIGS. 14A-14D, the hook latch assemblies 100 described herein may be able to transition from a folded configuration to an unfolded configuration. At FIG. 14A, the hook latch assembly 100 is in the folded configuration and the hook 101 is engaged with a clevis 200 of an aircraft. Additionally, the locking arms 121 are illustrated as engaging the protrusions 132 of the hook arm (the locking assembly is in the locked configuration), inhibiting the hook latch assembly 100 from transitioning to an unfolded configuration.

After a user presses the contact plate of the button 116, the locking arms 121 of the locking assembly pivot, disengaging from the protrusions 132 of the hook arm, and transitioning the locking assembly to the unlocked position. For example, the locking arms 121 may pivot between about between about 5 degrees to about 45 degrees around an axis defined by a pin (See FIGS. 20-21) inserted through the eyelets 255 of the locking arms 121 (FIGS. 10A-10C) and corresponding holes or apertures 176 (FIGS. 12A and 12B) of the handle 103 (e.g., Circle 906). This pivot or rotation may cause the protrusions 132 and the recesses 252 of the locking arms 121 to disengage. Once the locking assembly is in the unlocked position, the hook arm assembly is allowed to transition to the unfolded configuration. This transition is facilitated by the biasing member 124 (See FIG. 18) between the handle 103 and the hook arm. As described elsewhere, this biasing member 124 may be a spring having a first arm 212 engaging the hook arm and a second arm 211 engaging the handle 103. Thus, the spring may exert a force on both of these components, pushing the handle 103 away from the hook arm. In some embodiments, this biasing force may cause a gap Gi (FIG. 14B) to form between a proximal end (e.g., a link 105 end, as apposed to a hook/anchor end) of the connector 104 and a proximal end of the handle 103. Accordingly, the biasing member 124 may cause the hook latch assembly to transition to an intermediate configuration.

FIG. 14B depicts the hook latch assembly 100 in the intermediate configuration in-between the folded configuration (FIG. 14A) and a fully unfolded configuration (FIG. 14C). At this state, the handle 103 has partially pivoting around at least one of the hook arm and the connector 104. Further, a gap Gi between a proximal end (e.g., a link 105 end, as apposed to a hook/anchor end) of the connector 104 and a proximal end of the handle 103 forms. In some embodiments, the biasing member 124 (FIG. 18) may be sized and shaped to form a gap having a predetermined gap. For example, the biasing member 124 may create a gap between about three (3) inches to about fifteen (15) inches. A user may be required to pull the handle 103 to increase the size of the gap Gi and cause the hook latch 100 to transition to the fully unfolded configuration (FIG. 14C). In some embodiments, the biasing member 124 may be sized and shaped to transition the hook latch 100 from the folding configuration (FIG. 14A) to the fully unfolded configuration (FIG. 14C) without a user pulling on the handle 103. Further, as can be seen in a comparison of FIGS. 14A and 14B, the positioning of the link 105 may remain in a substantially similar position as the hook latch assembly 100 transitions from the folded configuration to the intermediate configuration illustrated in FIG. 14B. Because the link 105 has remained in a substantially similar position, the hook remains engaged to the clevis 200 of the airplane. Without wishing to be bound by theory, the hook remains engaged to the clevis 200 because the hook does not have enough clearance to disengage. For example, when the hook latch assembly 100 is in the folded configuration seen in FIG. 14A, a distance between an epicenter of the first end pivot point 905 of the link 105 and a tip 131 of the hook is a first length. This first length is insufficient to give the hook enough clearance to disengage and/or rotate away from the clevis 200 of the plane. The tip 131 of the hook would just contact the clevis 200.

FIG. 14C depicts the hook latch assembly 100 in the fully unfolded configuration. In the fully unfolded configuration, the link 105 has rotated about the first end pivot point 905, the mid-point rotation point 903 and the second end pivot point 904 have rotated about the first end pivot point 905, and the handle 103 and connector 104 have continued to rotate. Because the link 105 has rotated about the first end pivot point 905 and the mid-point rotation point 903 and the second end pivot point 904 have rotated about the first end pivot point 905, the size of the gap has increased (e.g., Gi to Gii, wherein Gii is greater than Gi). As illustrated in a comparison of FIGS. 14B and 14C, when the link 105 pivots about the first end pivot point 905, the positioning of the protrusion 145 of the link 105 changes. As seen in FIGS. 14A and 14B, the protrusion 145 of the link 105 positioned on a proximal side (toward the link side) of the first end pivot point 905 (e.g., the protrusion 145 is on the right side of the first end pivot point 905) when the hook latch assembly 100 is in the folded configuration (FIG. 14A) and/or the mid-point configuration (FIG. 14B). As seen in FIG. 14C, the protrusion 145 of the link 105 rotates across and/or around the first end pivot point 905 such that the protrusion 145 is on a distal side (toward the hook side) of the first end pivot point 905 (e.g., the protrusion 145 is on the left side of the first end pivot point 905). Put another way, as the hook latch assembly 100 transitions towards the fully unfolded configuration the link 105 rotates about the first end pivot point 905 such that a distance between the second end pivot point 904 and the clevis 200 decreases. Since the connector 104 is pivotably attached to both the link 105 and the handle 103, this transition causes the connector 104 to push the handle 103 in a distal direction (e.g., in a link 105 to hook direction), causing the gap to increase from Gi to Gii. For example, when the hook latch assembly 100 is in the unfolded configuration seen in FIG. 14C, a distance between an epicenter of the first end pivot point 905 of the link 105 and a tip 131 of the hook is a second length, larger than the first length. This second length is sufficient to give the hook enough clearance to disengage and/or rotate away from the clevis 200 of the plane. This unfolding of the hook latch 100 may cause a proximal portion of the handle 103 to extend beyond hook portion 101 of the hook arm (See FIG. 14C). In some embodiments, the handle 103 and the connector 104 form an obtuse angle.

Additionally, or alternatively, as illustrated in a comparison of FIGS. 14B and 14C, when the link 105 pivots about the first end pivot point 905, the positioning of the mid-point pivot point 903 of the link 105 changes. As seen in FIGS. 14A and 14B, the mid-point pivot point 903 of the link 105 positioned on a proximal side of the first end pivot point 905 (e.g., the mid-point pivot point 903 is on the right side of the first end pivot point 905) when the hook latch assembly 100 is in the folded configuration (FIG. 14A) or the mid-point configuration (FIG. 14B). As seen in FIG. 14C, the protrusion 145 of the link 105 rotates across and/or around the first end pivot point 905 such that the mid-point pivot point 903 is on a distal side of the first end pivot point 905 (e.g., the mid-point pivot point 903 is on the left side of the first end pivot point 905). Put another way, as the hook latch assembly 100 transitions towards the fully unfolded configuration the link 105 rotates about the first end pivot point 905 such that a distance between the mid-point pivot point 903 and the clevis 200 decreases. Since the hook arm is pivotably connected to the link 105 at the mid-point pivot point 903, this transition causes a distance between the first end pivot point 905 of the link 105 and the tip 131 of the hook to increase. As illustrated in FIG. 14C, this increase in distance may cause the hook to disengage from the clevis 200 of the aircraft.

To put another way, as the hook latch 100 (more specifically the link 105) transitions towards the fully unfolded configuration (FIG. 14C) the effective length of hook arm increases (e.g., L(i) to L(ii) when L(ii) is greater than L(i)). When the hook latch 100 is in the folded configuration (FIG. 14A), the effective length L(i) of the hook arm is the distance between the tip 131 of the hook and the proximal end of the hook arm (and/or the mid-point pivot point 903 of the link 105). However, when the hook latch 100 is in the fully unfolded configuration (FIG. 14C), the effective length L(ii) of the hook arm is the distance between the tip 131 of the hook and the proximal end of the hook arm and the longitudinal distance between the first end pivot point 905 of the link 105 and the mid-point pivot point 903 of the link 105. This change in effective length of the hook arm may be accomplished by the unique shape of the link 105. For example, the first end pivot point 905 and the mid-point pivot point 903 may a first axis. The mid-point pivot point 903 and the second end pivot point 904 may define a second axis. The first axis and the second axis are not parallel to each other. In some embodiments, the first axis and the second axis may be more perpendicular than parallel. As the link 105 rotates (the hook latch 100 transitions from the folded configuration to the unfolded configuration), the second axis transitions from extending in a generally along the Y-axis to extending generally along the X-axis (See FIGS. 14A-14C). This additional length allowed the hook arm to gain enough clearance to disengage from the hook. Accordingly, as illustrated in FIG. 14D, after the hook disengages with the mating clevis 200 of the aircraft, gravity may cause the distal end (toward the hook side) of the hook arm to fall. Since the first end pivot point 905 is connected to the aircraft, the proximal end of the hook latch 100 may not fall due to gravity.

A comparison of FIGS. 14A and 14D illustrates at least some of the high visibility aspects of the hook latches 100 described herein. When the hook latch 100 is in the folded and/or collapsed configuration, at least some of the components described in more detail above nested within each other and/or organized in a snug or compact manner. This efficient and compact organization is illustrated in FIGS. 15-17, which illustrates how each part is organized to create a small compact assembly. However, as illustrated in FIGS. 14C and 14D, when the hook latch 100 is in the fully expanded or unfolded configuration, the hook latch 100 is significantly larger when compared to the hook latch 100 in the collapsed and/or folded configuration. For example, a total length of the hook latch 100 increases when it transitions from the folded configuration to the unfolded configuration. Additionally, or alternatively, some components including the handle 103 have walls 133 that increase the visible surface area when the hook latch 100 hangs or dangles from the aircraft. For example, at least one of the visible surface area and the significant change in size (e.g., from the small folded configuration to the large unfolded configuration) may about double the visibility of the hook latch assembly 100. Further, when the hook latch 100 dangles, the increased total length of the hook latch 100 increases the visibility of the hook latch 100 when the hook latch 100 is detached from the clevis 200 of the aircraft.

### Terminology and Conclusion

Reference throughout this specification to “some embodiments” or “an embodiment” means that a particular feature, structure or characteristic described in connection with the embodiment is included in at least some embodiments. Thus, appearances of the phrases “in some embodiments” or “in an embodiment” in various places throughout this specification are not necessarily all referring to the same embodiment and may refer to one or more of the same or different embodiments. Furthermore, the particular features, structures or characteristics may be combined in any suitable manner, as would be apparent to one of ordinary skill in the art from this disclosure, in one or more embodiments.

As used in this application, the terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Similarly, it should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, inventive aspects lie in a combination of fewer than all features of any single foregoing disclosed embodiment.

A number of applications, publications, and external documents may be incorporated by reference herein. Any conflict or contradiction between a statement in the body text of this specification and a statement in any of the incorporated documents is to be resolved in favor of the statement in the body text.

The above-described embodiments are presented for purposes of illustration and not of limitation. While these embodiments have been described with reference to numerous specific details, one of ordinary skill in the art will recognize that the inventions can be embodied in other specific forms without departing from the spirit of the description, and that the disclosure extends beyond the specifically described embodiments to other alternative embodiments and/or uses and obvious modifications and equivalents. Thus, one of ordinary skill in the art would understand that the inventions are not to be limited by the foregoing illustrative details, but rather are to be defined by any claims that may be appended hereto or supported hereby.

1. A high visibility hook latch comprising:
a hook arm comprising:
an arm having a distal end and a proximal end;
a hook positioned at the distal end of the arm, the hook having a distal end;
wherein the hook arm is configured to transition from a first configuration to a second configuration, wherein a distance between the proximal end of the arm and the distal end of the hook comprises a first length when the hook arm is in the first configuration and the distance comprises a second length when the hook arm is in the second configuration, the second length different from the first length;
a handle pivotably attached to the distal end of the arm;
a connector having a proximal end and a distal end, the distal end of the connector pivotably attached to the handle; and
a link, wherein the proximal end of the arm is pivotably attached to the link and the proximal end of the connector is pivotably attached to the link.

2. The high visibility hook latch of claim 1, wherein the arm comprises a female portion and a male portion configured to be inserted into the female portion.

3.-7. (canceled)

8. The high visibility hook latch of claim 2, wherein at least a portion of the male portion of the hook comprises threads, and wherein the hook arm further comprises an adjustable nut configured to threadingly engage the threads of the male portion.

9. (canceled)

10. The high visibility hook latch of claim 8, wherein the adjustable nut is further configured to rotate in a first direction, wherein the hook arm is configured to transition from the first configuration to the second configuration when the adjustable nut is rotated in the first direction.

11. (canceled)

12. The high visibility hook latch of claim 10, wherein the adjustable nut is further configured to rotate in a second direction, opposite the first direction, wherein the hook arm is configured to transition from the second configuration to the first configuration when the adjustable nut is rotated in the second direction.

13.-21. (canceled)

22. The high visibility hook latch of claim 10, further comprising a hook stabilizer configured to inhibit the hook from rotating when the adjustable nut is rotated, the hook stabilizer comprising a plate having an aperture and a projection extending generally towards a center of the aperture.

23.-26. (canceled)

27. The high visibility hook latch of claim 22, wherein the plate further comprises a first end, a second end opposite the first end, and a flange extending from the first end.

28.-29. (canceled)

30. The high visibility hook latch of claim 22, wherein the adjustable nut includes at least one of a distal side, a proximal side, and a cylindrical surface, wherein the hook stabilizer includes at least one of a distal side and a proximal side having one or more projections, and wherein the distal side of the adjustable nut includes one or more grooves configured receive the one or more projections of the hook stabilizer.

31. -33. (canceled)

34. The high visibility hook latch of claim 30, wherein the one or more projections of the hook stabilizer are configured to engage the one or more grooves of the adjustable nut, and wherein the engagement of the one or more projections and the one or more grooves inhibit the hook from rotating relative to the hook stabilizer.

35-314. (canceled)

315. A hook latch assembly comprising:
a base;
a door;
a high visibility hook latch configured to be retrofitted on aircraft for holding the door in a closed position relative to the base, the latch comprising:
a hook arm;
a handle pivotably attached to a distal end of the hook arm;
a connector having a proximal end and a distal end, the distal end of the connector pivotably attached to the handle; and
a link, wherein the proximal end of the hook arm is pivotably attached to the link and the proximal end of the connector is pivotably attached to the link.

316.-350. (canceled)

351. The hook latch assembly of claim 315, further configured to transition from a folded configuration to a deployed configuration, wherein the hook latch assembly further comprises a locking assembly configured to inhibit the high visibility hook latch from transitioning from the folded configuration to the deployed configuration.

352. (canceled)

353. The hook latch assembly of claim 351, wherein the locking assembly comprises one or more protrusions extending from the hook arm and one or more locking arms configured to engage the one or more protrusions, wherein the engagement of the one or more protrusions and the one or more locking arms inhibit the high visibility hook latch from transitioning from the folded configuration to the deployed configuration.

354.-357. (canceled)

358. The hook latch assembly of claim 353, wherein the one or more locking arms are configured to transition from a locked position to an unlocked position, wherein the high visibility hook latch is configured to be inhibited from transitioning from the folded configuration to the deployed configuration when the one or more locking arms are in the locked position.

359. (canceled)

360. The hook latch assembly of claim 358, wherein the high visibility hook latch is configured permit to transition from the folded configuration to the deployed configuration when the one or more locking arms are in the unlocked position.

361. The hook latch assembly of claim 360, wherein the locking assembly further comprises a button supporting the one or more locking arms, the button configured to transition the locking assembly from the locked position to the unlocked position.

362.-365. (canceled)

366. The hook latch assembly of claim 361, wherein the locking assembly further comprises a biasing member configured to bias the locking assembly towards the locked position.

367.-377. (canceled)

378. The hook latch assembly of claim 361, wherein the one or more locking arms are configured to disengage from the one or more protrusions when the button is pressed, wherein the high visibility hook latch is configured to transition from the folded configuration to the deployed configuration after the one or more locking arms disengage.

379.-433. (canceled)

434. A hook latch configured to be retrofitted in a cowling system, the hook latch comprising:
an elongate hook arm having a hook at a hook end;
a handle pivotably attached to the hook arm at the other end, away from the hook end;
an elongate connector having a link end and a handle end, the handle end of the connector pivotably attached to the handle;
a link comprising a main connection point configured to connect to the exterior of an aircraft engine, a hook-arm pivot point, and a connector pivot point, the hook end of the hook arm is pivotably attached to the link at the hook-arm pivot point, and the link end of the connector is pivotably attached to the link at the connector pivot point; and
the hook-arm pivot point of the link and the connector pivot point of the link are configured to respond to a force on the handle in a direction away from the aircraft to begin a disconnection process by simultaneously pivoting around the main connection point away from the exterior of the aircraft engine, thereby lengthening the distance between the main connection point and the hook end of the elongate hook arm.

435.-436. (canceled)

437. The hook latch of claim 434, further configured to transition from a folded configuration to an unfolded configuration, wherein the hook-arm pivot point pivot point is configured to at least partially orbit the main connection point as the hook latch transitions from the folded configuration to the unfolded configuration.

438. (canceled)

439. The hook latch of claim 434, further configured to transition from a folded configuration to an unfolded configuration, wherein the connector pivot point is configured to at least partially orbit the main connection point as the hook latch transitions from the folded configuration to the unfolded configuration.

440.-443. (canceled)
